(19) United States
(12) Patent Application Publication
(10) Pub. No.: US 2008/0247332 A1
(43) Pub. Date: Oct. 9, 2008

(54) Network Configuration Management Method, Network Band Management Method, Network Participation Method, and Communication Terminal Device

(76) Inventors: Toshimitsu Sato, Tokyo (JP); Sadayuki Inoue, Tokyo (JP); Tetsuro Shida, Tokyo (JP); Tsuyoshi Kasaura, Tokyo (JP); Soichiro Matsumoto, Tokyo (JP); Masahiro Tsujishita, Tokyo (JP)

Correspondence Address: BIRCH STEWART KOLASCH & BIRCH, PO BOX 747, FALLS CHURCH, VA, 22040-0747, US

(21) Appl. No.: 10/587,044

(22) PCT Filed: Dec. 14, 2004
(86) PCT No.: PCT/JP04/18615

§ 371 Date: Jul. 24, 2006

(30) Foreign Application Priority Data
Feb. 12, 2004 (JP) 2004-034559
May 21, 2004 (JP) 2004-151451

(51) Int. Cl. H04L 12/28

(52) U.S. Cl. 370/254

(57) ABSTRACT

A network configuration management includes the steps of sending from the management terminal (1100) participation terminal information stored in the management terminal; receiving by the participation terminal (1200, 1300, 1400) other than the management terminal, participation terminal information sent from the management terminal (1100); judging by the participation terminal other than the management terminal, whether or not the participation terminal can communicate with another participation terminal device that is participating in a wireless network (1010); sending a communication availability judgment result which is obtained by the judging step, from the participation terminal other than the management terminal to the management terminal (1100); and determining by the management terminal (1100), a participation terminal that should be excluded from the wireless network (1010) in accordance with the communication availability judgment result, and deleting by the management terminal device, from the participation terminal information the participation terminal that should be excluded from the wireless network (1010), thereby updating the participation terminal information which is stored in the management terminal.

### TECHNICAL FIELD

The present invention relates to a method of managing a configuration of a network which is constructed so that a plurality of communication terminal devices (hereinafter also referred to as a “communication terminal” or “terminal”) can directly communicate with each other, a method of managing a communication band in a network, a method of participating in a network, and a communication terminal device which forms a network.

### BACKGROUND ART

Recently, wireless networks are widely used in offices and homes because of their merits that they are free from troublesome wiring in wired networks and that their layouts can be flexibly changed. For constructing a wireless network, there are two types of method: in one method, an access point is used and terminals always communicate with each other via the access point, and in the other method, no access point is used and terminals directly communicate with each other.

In a method using the access point, the terminals always communicate with each other via the access point. So, if each of the terminals can communicate with the access point, each of the terminals can communicate with all the other terminals. However, in order to construct a wireless network by using a method with the access point, the access point is always required, and the terminals cannot communicate with each other if there is no access point. Since the number of communication paths is doubled because of intervention of the access point, an available communication band is halved in comparison with that of a method without the access point.

On the other hand, in a method that the terminals directly communicate with each other without using an access point, a wireless network can be constructed by the terminals only and any extra equipment such as an access point is not required. However, whereas in the method using the access point, all the terminals can communicate with each other if each of the terminals can communicate with the access point, in the method that the terminals directly communicate with each other, the communication in the network is not be ensured if the terminals cannot directly communicate with each other.

Patent document 1 shows a wireless communication system, a wireless communication terminal, and a method of participating in a wireless communication system, which ensure communication reachability between a terminal which newly participates in the network and all the other terminals, in a wireless network in which the terminals directly communicate with each other without an access point.

Further, a wireless system, in which wireless terminals send/receive multimedia data such as a motion picture to/from each other, is achieved. In such a system, in order to ensure communication reachability, an appropriate management of a communication band between the terminals, which send/receive multimedia data to/from each other, is required.

Furthermore, patent document 1 also shows a transmission method with a certain quality maintained when multimedia data is transmitted in the wireless network.

Patent document 1: Japanese Patent Application Kokai (Laid-Open) Publication No. 2003-318917

Patent document 2: Japanese Patent Application Kokai (Laid-Open) Publication No. 2002-111728

### DISCLOSURE OF INVENTION

### PROBLEMS TO BE SOLVED BY THE INVENTION

However, the wireless network described in the patent document 1 has a problem that the communication terminals which can communicate with each other at a certain moment cannot communicate at another moment due to a change in communication condition between the communication terminals which is caused by moving the communication terminal to another place and so forth.

Further, in a wireless network, the communication condition between terminals changes with a lapse of time and the transmission rate changes in accordance with a transmission error and so forth. For example, IEEE 802.11a standard provides 6 Mbps, 9 Mbps, 12 Mbps, 18 Mbps, 24 Mbps, 36 Mbps, 48 Mbps and 54 Mbps as available transmission rates; if communication is in very good condition, data transmission at 54 Mbps is performed; and if communication is in very bad condition, data transmission is performed at 6 Mbps. An object of the invention disclosed in patent document 1 is to ensure communication reachability between a new terminal and all the terminals that are participating in the wireless network when the new terminal participates in the wireless network. For this reason, the network disclosed in patent document 1 has a problem that a communication band may not be appropriately managed when a transmission rate is changed due to a change in the communication condition.

Furthermore, in the wireless network, even if the communication reachability at a certain transmission rate is ensured, communication may not be performed when a transmission rate is larger than the certain transmission rate. For example, even if the communication reachability is ensured when the minimum transmission rate supported by the wireless system is used, communication may not be always performed when a transmission rate is larger than the minimum transmission rate. An object of the invention disclosed in patent document 1 is to ensure the communication reachability among all the terminals that are participating in the network. Therefore, there are problems in the network disclosed in patent document 1: a transmission rate that ensures communication reachability between the terminals that are participating in the wireless network cannot be acquired, and a certain quality of communication in the network cannot be ensured even if the certain quality of communication in the network is required.

Moreover, although an invention disclosed in patent document 2 includes consideration of an increase in a frequency of re-sending when a transmission error occurs, the invention does not address a change in the communication band when a transmission rate in use is changed. For this reason, a wireless network disclosed in patent document 2 has a problem that the communication band may not be appropriately managed when the transmission rate in use changed due to a change in the communication condition.

Therefore, it is an object of the present invention to provide a network configuration management method used in a network allowing the terminals to directly communicate with each other, wherein communication reachability can be continuously ensured among the terminals that are participating in the network, and a communication terminal device forming such network.

Further, it is another object of the present invention to provide a network band management method which can appropriately manage a communication band even if a transmission rate changes.

Furthermore, it is still another object of the present invention is to provide a network participation method used in a network allowing the terminals to directly communicate with each other, wherein communication reachability among the terminals that are participating in the network can be ensured and an available transmission rate that the terminals can communicate with each other can be acquired, a network configuration management method for such network, and a communication terminal device forming such network.

### MEANS FOR SOLVING THE PROBLEM

A network configuration management method of the present invention manages a network configuration in such a way that a participation terminal device can directly communicate with another participation terminal device, wherein a network includes a plurality of communication terminal devices each having a unique terminal identifier, one of the plurality of communication terminal devices is a management terminal device, and a communication terminal device which is permitted by the management terminal device to participate in the network is the participation terminal device. The network configuration management method includes the steps of: sending from the management terminal device, participation terminal information stored in the management terminal device; receiving by the participation terminal device other than the management terminal device, the participation terminal information sent from the management terminal device; judging by the participation terminal device other than the management terminal device, whether or not the participation terminal device can communicate with another participation terminal device that is participating in the network; sending a communication availability judgment result obtained by the step of judging, from the participation terminal device other than the management terminal device to the management terminal device; and determining by the management terminal device, a participation terminal device that should be excluded from the network in accordance with the communication availability judgment result, and deleting by the management terminal device, the participation terminal device that should be excluded from the network from the participation terminal information, thereby updating the participation terminal information stored in the management terminal device.

Further, a network band management method of the present invention is used in a network that includes a plurality of communication terminals including a single management terminal and a plurality of managed terminals, the plurality of the communication terminals in the network directly communicating with each other. The network band management method includes the steps of: giving notice of sending information which contains information regarding band for data transmission being used by the own communication terminal, from the plurality of the managed terminals to the management terminal; generating by the management terminal, band-in-use information regarding a band being used in the network, in accordance with the notified sending information; and giving notice of the generated band-in-use information from the management terminal to the plurality of the managed terminals.

Furthermore, a network participation method of the present invention is provided for participating in a network by a participation requesting terminal, wherein the network includes a plurality of communication terminals each having a unique terminal identifier, one of the plurality of communication terminals is a management terminal, and the communication terminals that are participating in the network can directly communicate with each other and can acquire available transmission rates each other. The network participation method includes the steps of: receiving participation terminal information of the communication terminal that is participating in the network, the participation terminal information being sent from the management terminal at regular intervals; judging communication availability judgment indicating whether communication with the communication terminals that are participating in the network can be performed and available transmission rates in accordance with the participation terminal information; sending a participation request which contains a result of the transmission rate judgment to the management terminal;

receiving a participation permissibility judgment result indicating whether the participation requesting terminal can participate in the network or not, the participation permissibility judgment result being sent from the management terminal, as a result of the participation request sending; and determining network participation permissibility in accordance with the received participation permissibility judgment result

Moreover, another network configuration management method of the present invention is provided for managing a network configuration by a management terminal, wherein the network includes a plurality of communication terminals each having a unique terminal identifier, one of the plurality of communication terminals is the management terminal, and the communication terminals that are participating in the network can directly communicate with each other and can acquire available transmission rates each other. The network configuration management method includes the steps of: giving notice of participation terminal information of the communication terminal that is participating in the network, to the communication terminal in the network, by broadcasting at regular intervals; receiving a participation request being sent from a participation requesting terminal requesting to newly participate in the network, the participation request which contains communication availability information indicating whether communication with the communication terminals that is participating in the network can be performed or not and a result of available transmission rate judgment; judging whether participation of the participation requesting terminal in the network can be permitted or not in accordance with the received participation request; sending a network participation permissibility judgment result regarding the participation of the participation requesting terminal to the participation requesting terminal; updating the participation terminal information in accordance with the participation permissibility judgment, if the participation requesting terminal can participate in the network; and sending the participation terminal information to the communication terminal that is participating in the network, if the participation terminal information is updated.

### EFFECTS OF THE INVENTION

In a network configured according to the present invention, there is an advantage that communication reachability between the communication terminals that are participating in the network can be continuously ensured, even if the communication condition changes.

Further, according to the present invention, a communication band can be appropriately managed, even if a transmission rate changes. Furthermore, since a network is configured so that the communication terminals can directly communicate with each other without an access point, there is another advantage that the communication band can be used twice as much as that in a network using an access point for communication.

Moreover, according to the present invention, if the present invention includes the steps of: receiving participation terminal information of the communication terminal that is participating in the network, the participation terminal information being sent from the management terminal at regular intervals; judging communication availability judgment indicating whether communication with the communication terminals that are participating in the network can be performed and available transmission rates, in accordance with the participation terminal information; sending a participation request which contains a result of the transmission rate judgment to the management terminal; receiving a participation permissibility judgment result indicating whether the participation requesting terminal can participate in the network or not, the participation permissibility judgment result being sent from the management terminal, as a result of the participation request sending; and determining network participation permissibility in accordance with the received participation permissibility judgment result, there is another advantage that a network can be realized in which all the terminals that are participating in the network can directly communicate with each other without an access point, the terminals can acquire available transmission rates for communication between the terminals, and the transmission rate of a predetermined or better communication quality can be maintained, in comparison with a network communication reachability ensuring method.

Furthermore, there is another advantage that communication can be efficiently performed by acquiring available transmission rates for communication between terminals. For example, when a terminal performs broadcast communication, in a network which ensures only communication reachability, the communication can be performed only at a transmission rate or less whose communication availability is confirmed. On the other hand, in a network of the present invention, a terminal can communicate with all terminals in the network by using the maximum available transmission rate at the time. Accordingly, data transmission using a low transmission rate can be reduced and the network can be efficiently used.

### BRIEF DESCRIPTION OF DRAWINGS

FIG. 1 is a diagram showing a configuration of a wireless network, to which a management method according to the first embodiment of the present invention is applied;

FIG. 2 is a block diagram schematically showing a configuration of a management terminal in the first embodiment;

FIG. 3 is an explanatory diagram showing participation terminal information stored in the management terminal in the first embodiment;

FIG. 4 is a block diagram schematically showing a configuration of a communication terminal other than the management terminal in the first embodiment;

FIG. 5 is an explanatory diagram showing participation terminal information stored in a communication terminal other than the management terminal in the first embodiment;

FIG. 6 is a diagram showing a configuration when communication in the wireless network of FIG. 1 is unavailable;

FIG. 7 is an explanatory diagram showing participation terminal information stored in a communication terminal other than the management terminal in FIG. 6;

FIG. 8 is an explanatory diagram showing participation terminal information stored in another communication terminal other than the management terminal in FIG. 6;

FIG. 9 is an explanatory diagram showing participation terminal information stored in another communication terminal other than the management terminal in FIG. 6;

FIG. 10 is an explanatory diagram showing participation terminal information stored in the management terminal in FIG. 6;

FIG. 11 is a diagram showing a configuration of the wireless network when one of the communication terminals is excluded from the wireless network in FIG. 6;

FIG. 12 is an explanatory diagram showing participation terminal information stored in the management terminal in FIG. 11;

FIG. 13 is an explanatory diagram showing participation terminal information stored in the communication terminal other than the management terminal in FIG. 11;

FIG. 14 is an explanatory diagram showing participation terminal information stored in the communication terminal other than the management terminal in FIG. 11;

FIG. 15A is a flowchart showing a sending operation of the participation terminal information by the management terminal in the first embodiment, and FIG. 15B is a flowchart showing the receiving operation of communication availability judgment result by the management terminal in the first embodiment;

FIG. 16 is a flowchart showing an operation of the communication terminal other than the management terminal in the first embodiment;

FIG. 17 is a flowchart showing an operation of the communication terminal other than the management terminal in the second embodiment of the present invention;

FIG. 18 is a flowchart showing an operation of the management terminal in the second embodiment;

FIGS. 19A to 19C are flowcharts showing operations of the communication terminal other than the management terminal in the third embodiment of the present invention, wherein FIG. 19A shows a sending operation of data for communication availability judgment, FIG. 19B shows a judging operation of the communication availability, and FIG. 19C shows a receiving operation of data for communication availability judgment;

FIG. 20 is a block diagram showing a configuration of a communication terminal in a modified example of the first embodiment;

FIG. 21 is a block diagram showing a configuration of a communication terminal in a modified example of the second embodiment;

FIG. 22 is a block diagram showing a configuration of a management terminal in the modified example of the first embodiment;

FIG. 23 is a block diagram showing a configuration of a management terminal in the modified example of the second embodiment;

FIG. 24 is a diagram showing a configuration example of a wireless network, to which a communication band management method according to the fourth embodiment of the present invention is applied;

FIGS. 25A and 25B are flowcharts showing operations of a wireless communication terminal in the fourth embodiment;

FIG. 26 is a diagram showing an example of band-in-use information in the fourth embodiment;

FIG. 27 is a diagram showing an example of a relationship between the wireless transmission rates and the communication bands in the fourth embodiment;

FIGS. 28A to 28D are flowcharts showing operations of the wireless communication terminal in the fourth embodiment;

FIG. 29 is a diagram showing an example of the maximum transmission rates in the fourth embodiment;

FIG. 30 is a diagram showing an example of communication band management information in the fourth embodiment;

FIG. 31 is a diagram showing a configuration example of the wireless network in the fourth embodiment;

FIG. 32 is a diagram showing another example of the band-in-use information in the fourth embodiment;

FIG. 33 is a diagram showing another example of the communication band management information in the fourth embodiment;

FIG. 34 is a flowchart showing an operation of a wireless communication terminal in the fifth embodiment of the present invention;

FIG. 35 is a diagram showing a configuration example of a wireless network, to which a participation method and a management method according to the sixth to eighth embodiments in the present invention are applied;

FIG. 36 is a flowchart showing an operation of a wireless communication terminal which forms a wireless network in the sixth embodiment;

FIG. 37 is a flowchart showing an operation of a management terminal which forms the wireless network in the sixth to eighth embodiments;

FIG. 38 is a flowchart showing an operation of the management terminal which forms the wireless network in the sixth embodiment;

FIG. 39 is a diagram showing an example of available transmission rates between the wireless communication terminals in the sixth embodiment;

FIG. 40 is a flowchart showing an example of a transmission rate judgment process of the wireless communication terminal of the wireless network in the sixth embodiment;

FIG. 41 is a diagram showing an example of the participation terminal information in the sixth embodiment;

FIG. 42 is a diagram showing an example of the participation terminal information in the sixth embodiment;

FIG. 43 is a flowchart showing an operation of a wireless communication terminal which forms a wireless network in the seventh embodiment;

FIG. 44 is a flowchart showing an operation of a management terminal which forms the wireless network in the seventh embodiment;

FIG. 45 is a diagram showing an example of available transmission rates between the wireless communication terminals in the seventh embodiment;

FIG. 46 is a flowchart showing an example of a participation permissibility judgment operation of the management terminal in wireless network in the seventh embodiment;

FIG. 47 is a diagram showing an example of available transmission rates for communication between wireless communication terminals in the seventh embodiment;

FIG. 48 is a diagram showing another example of available transmission rates for communication between the wireless communication terminals in the seventh embodiment;

FIG. 49 is a diagram showing an example of priority to the wireless communication terminal in the seventh embodiment;

FIG. 50 is a diagram showing an example of the participation terminal information in the seventh embodiment;

FIG. 51 is a diagram showing a configuration example of a wireless network in the seventh embodiment;

FIG. 52 is a diagram showing an example of an excluded terminal list in the seventh embodiment;

FIG. 53 is a diagram showing part of the transmission rate judgment information of a wireless communication terminal in the seventh embodiment;

FIG. 54 is a diagram showing part of the transmission rate judgment information of another wireless communication terminal in the seventh embodiment;

FIG. 55 is a diagram showing an example of an excluded terminal list in the seventh embodiment;

FIG. 56 is a flowchart showing an operation of a wireless communication terminal which forms a wireless network in the eighth embodiment;

FIG. 57 is a flowchart showing an operation of a management terminal which forms the wireless network in the eighth embodiment;

FIG. 58 is a block diagram showing a configuration of a wireless communication terminal in a modified example of the sixth to eighth embodiments;

FIG. 59 is a block diagram showing a configuration of a wireless communication terminal in another modified example of the sixth to eighth embodiments;

FIG. 60 is a block diagram showing a configuration of a management terminal in a modified example of the sixth to eighth embodiments; and

FIG. 61 is a block diagram showing a configuration of a management terminal in another modified example of the sixth to eighth embodiments.

### EXPLANATION OF REFERENCE SYMBOLS

1010, 1010a wireless network; 1100 wireless communication terminal (management terminal); 1200, 1300, 1400 wireless communication terminal (wireless communication terminal other than management terminal); 1101, 1201 communication section; 1102, 1202 control section; 1103, 1203 storage section; 1104, 1204 display section; 1501 communication section; 1502 participation terminal information receiving section; 1503a, 1503b communication availability judging section; 1504 communication availability judgment result sending section; 1505 exclusion notification receiving section; 1506a, 1506b exclusion judging section; 1601 communication section; 1602 participation terminal information sending section; 1603 participation permissibility judging section; 1604 exclusion notification sending section; 1605 communication availability judgment result receiving section; 2101 wireless communication terminal (management terminal); 2103-2104 wireless communication terminal (wireless communication terminal other than management terminal); 2110, 2110a wireless network; 2801, 2803, 2804 TV; 2802 STB; 3101 wireless communication terminal (management terminal); 3102-3104 wireless communication terminal other than management terminal; 3105 wireless communication terminal (participation requesting terminal); 3110, 3110a wireless network; 4301 communication section; 4302 participation terminal information receiving section; 4303 transmission rate judging section; 4304 transmission rate judgment information sending section; 4305 participation request sending section; 4306 participation requesting section; 4307 exclusion notification receiving section; 4308a, 4308b exclusion judging section; 4501 communication section; 4502 participation request receiving section; 4503 participation terminal information sending section; 4504 participation terminal information updating section; 4505 participation permissibility judging section; 4506 exclusion notification sending section; 4507 transmission rate judgment information receiving section.

### BEST MODE FOR CARRYING OUT THE INVENTION

### First Embodiment

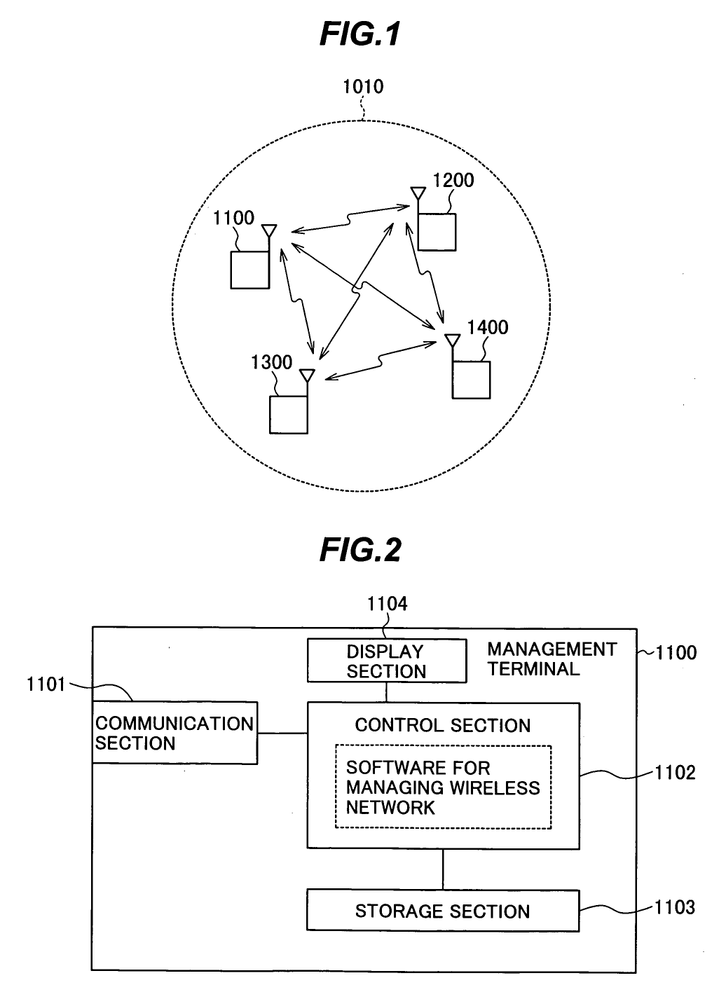

FIG. 1 is a diagram showing a configuration of a wireless network 1010, to which a management method according to the first embodiment of the present invention is applied. As shown in FIG. 1, the wireless network 1010 in the first embodiment includes communication terminals 1100, 1200, 1300 and 1400. The communication terminals 1100, 1200, 1300 and 1400 are a plurality of communication equipments with wireless communication functions such as a plurality of mobile phones, a plurality of personal computers (PC), a combination of a PC and its peripheral equipment, or a plurality of video equipments (such as a broadcast receiver, a video recorder and a video display unit), for example. The communication terminals 1100, 1200, 1300 and 1400 are configured to be able to communicate directly with each other, without using an access point. In FIG. 1, solid double-headed arrows indicate that communication reachability between the communication terminals is ensured. Although FIG. 1 shows an example that four communication terminals form the wireless network 1010, the number of the communication terminals forming the wireless network 1010 is not limited to four. Further, for example, one of the communication terminals 1100, 1200, 1300 and 1400 is a management terminal device (hereinafter referred to as “management terminal”) which has a function of managing the configuration of the wireless network 1010. A case where the communication terminal 1100 is the management terminal will be described. The communication terminals 1100, 1200, 1300 and 1400 are communication terminals that are participating in the wireless network 1010 (that is, the communication terminals which are allowed by the management terminal to participate in the wireless network), and therefore they are also referred to as participation terminal devices or participation terminals (or managed terminals).

FIG. 2 is a block diagram schematically showing a configuration of the management terminal 1100. As shown in FIG. 2, the management terminal 1100 includes a communication section 1101 which performs wireless communication with the other communication terminals; a control section 1102 which can cause each component in the management terminal 1100 to execute operations in accordance with the wireless network management software; and a storage section 1103 such as a semiconductor memory. Further, the management terminal 1100 optionally includes various kinds of components, for example, an operation section (not shown in the figure) as a user interface, a display section 1104 such as a liquid crystal display, an audio output section (not shown in the figure) such as a speaker, an audio input section (not shown in the figure) such as a microphone, and a power supply section (not shown in the figure).

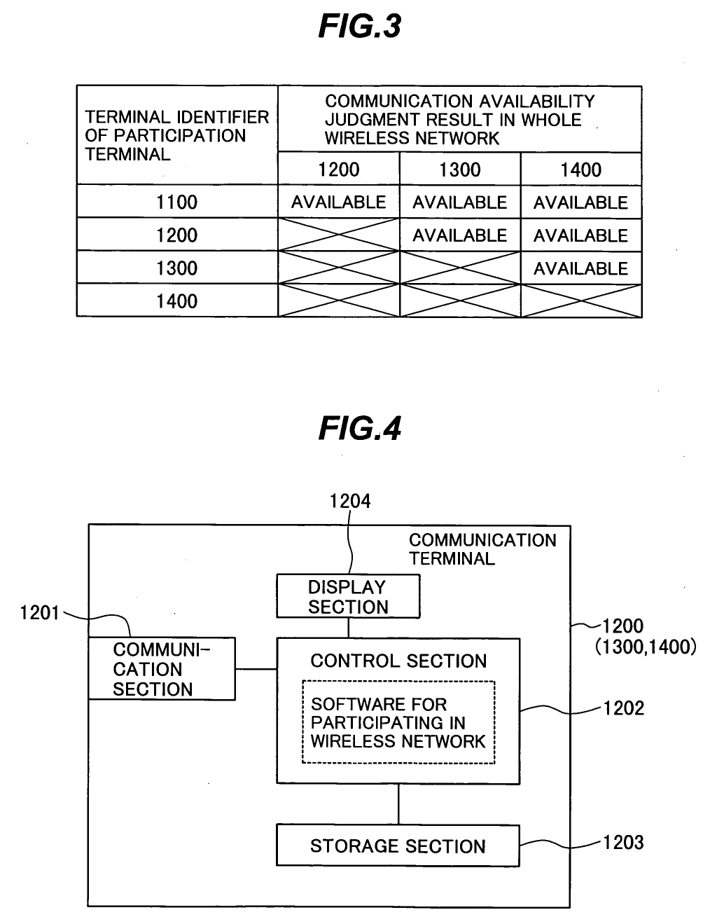

FIG. 3 is an explanatory diagram showing participation terminal information stored in the storage section 1103 of the management terminal 1100. As shown in FIG. 3, the participation terminal information is information regarding a participation terminal that is participating in the wireless network 1010. The participation terminal information contains information for specifying a participation terminal that is participating in the wireless network 1010 by its unique terminal identifier and communication availability judgment result information (i.e., communication availability judgment result in the whole wireless network 1010) which indicates whether the participation terminal is in a communication available state where the participation terminals can communicate with each other (shown as “AVAILABLE” in FIG. 3) or in a communication unavailable state where the participation terminals cannot communicate with each other. Further, in the following description, the terminal identifiers of the communication terminals 1100, 1200, 1300 and 1400 are “1100”, “1200”, “1300” and “1400” respectively.

FIG. 4 is a block diagram schematically showing a configuration of the communication terminals 1200, 1300 and 1400. As shown in FIG. 4, each of the communication terminals 1200, 1300 and 1400 includes a communication section 1201 which performs wireless communication with other communication terminals; a control section 1202 which can cause the components in the communication terminal to execute operations in accordance with wireless network participation software; and a storage section 1203 such as a semiconductor memory. Further, each of the communication terminals 1200, 1300 and 1400 is optionally provided with various kinds of components including an operating section (not shown in the figure) as a user interface, a display section 1204 such as a liquid crystal display, an audio output section (not shown in the figure) such as a speaker, an audio input section (not shown in the figure) as a microphone, a power supply section (not shown in the figure) and so forth.

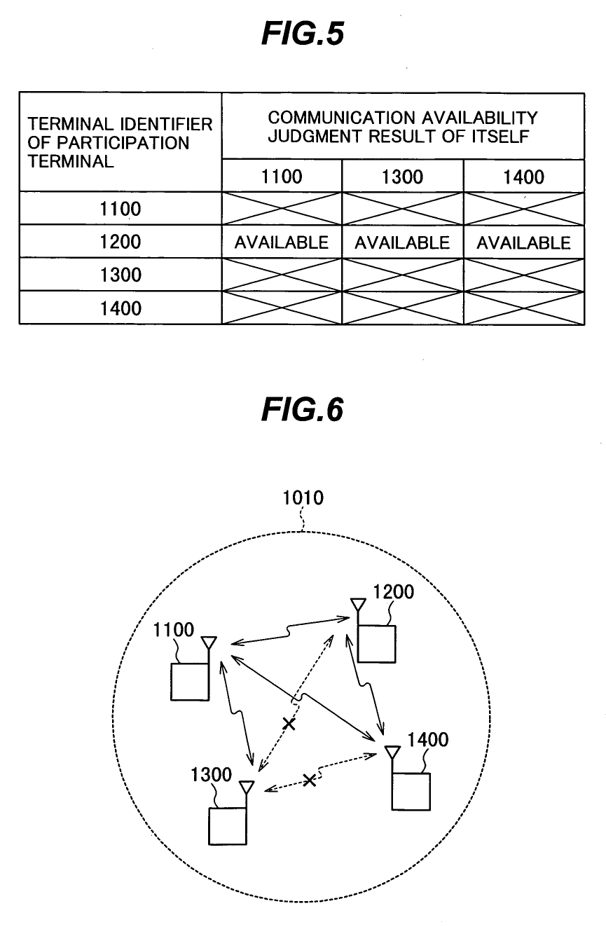

FIG. 5 is an explanatory diagram showing participation terminal information stored in the storage section 1203 of a communication terminal 1200. As shown in FIG. 5, the participation terminal information contains information for specifying a participation terminal that is participating in the wireless network 1010 by its unique terminal identifier (information received from the management terminal 1100) and communication availability judgment result information which indicates whether the terminal is in a communication available state where the terminal itself can communicate with another participation terminal (shown as “AVAILABLE” in the figure) or in a communication unavailable state where the terminal itself cannot communicate with another participation terminal (shown as “UNAVAILABLE” in the figure). Further, the participation terminal information stored in the storage section of the communication terminal 1300 or 1400 is substantially the same as the information shown in the explanatory diagram of FIG. 5 (however, their communication availability judgment results are different).

Next, the network configuration management method according to the first embodiment will be outlined. The wireless network 1010 manages the wireless network as follows.

First, the management terminal 1100 sends the participation terminal information stored in the management terminal itself In Step A. The sent participation terminal information is the updated participation terminal information in Step D described below. However, at a stage before the management terminal 1100 receives the participation terminal information (such as an initial stage of constitution of the wireless network 1010), the participation terminal information may be set to an initial stage by a user's operation or the like.

In Step B, the communication terminals 1200, 1300 and 1400 receive the participation terminal information sent from the management terminal 1100.

In the next Step C, the communication terminals 1200, 1300 and 1400 judge whether or not they can communicate with the other communication terminals, which are participating in the wireless network 1010, in accordance with the received participation terminal information.

In the next Step D, the communication terminals 1200, 1300 and 1400 send to the management terminal 1100 a communication availability judgment result obtained by the judgment whether they can communicate or not.

In step E, the management terminal 1100 determines a participation terminal that should be excluded from the wireless network 1010 in accordance with the received communication availability judgment result. The determination of the terminal that should be excluded is performed, for example, when the terminal successively fails to communicate a predetermined number of times, or when the number of the failure in communication during a predetermined time period exceeds a predetermined number, or when priority is provided to each of the participation terminals and a participation terminal which cannot perform communication and has low priority is determined to be excluded. By deleting the participation terminal that should be excluded from the wireless network 1010 from the participation terminal information, the participation terminal information stored in the management terminal 1100 is updated. If there is a participation terminal that should be excluded from the wireless network 1010, the management terminal 1100 sends a notice of exclusion for notifying the participation terminal that should be excluded from the wireless network 1010 of the deletion of the participation terminal from the wireless network 1010.

Further, processes of Steps A to E are repeated in the wireless network 1010, for example, at regular intervals in Step F.

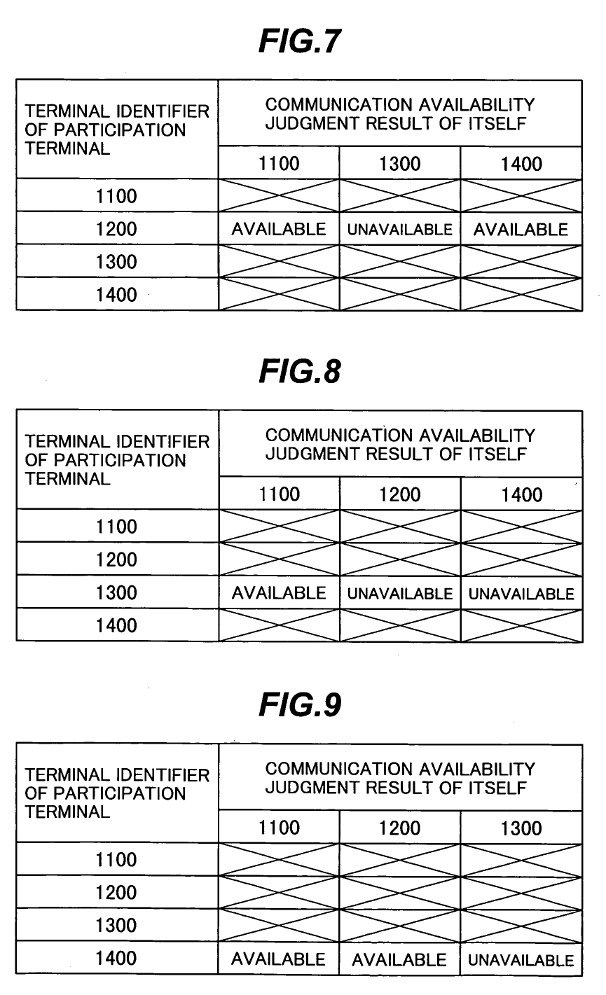

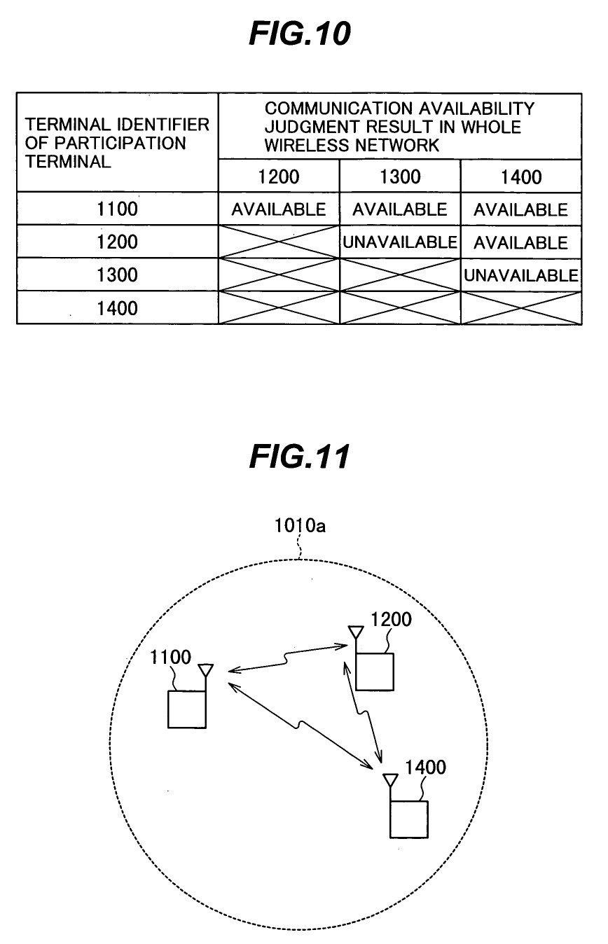

An example will be described that, in the wireless network 1010 formed by the four communication terminals 1100, 1200, 1300 and 1400 as shown in FIG. 1, the communication terminals 1200 and 1300 cannot communicate with each other and the communication terminals 1300 and 1400 cannot communicate with each other due to a change in the communication condition, as shown by double-headed arrows (dotted lines) with crosses “X” in FIG. 6. In this case, in Step C, the communication terminals 1200, 1300 and 1400 judge whether or not they can communicate with the other communication terminals, which are participating in the wireless network 1010, and in Step D, the communication terminals 1200, 1300 and 1400 send the communication availability judgment result obtained as a result of the judgment to the management terminal 1100. At the time of the sending, the communication availability judgment result information stored in each of the communication terminals 1200, 1300 and 1400 indicates, as shown in FIG. 7, FIG. 8 and FIG. 9 respectively, that the communication terminals 1200 and 1300 cannot communicate with each other and the communication terminals 1300 and 1400 cannot communicate with each other (shown as “UNAVAILABLE” in the figure). In Step E, the management terminal 1100 determines a participation terminal that should be excluded from the wireless network 1010 in accordance with the received communication availability judgment result, and deletes information of the participation terminal that should be excluded from the wireless network 1010 from the participation terminal information to update the participation terminal information stored in the management terminal 1100. As shown in FIG. 10, the updated participation terminal information stored in the management terminal 1100 indicates that the communication terminals 1200 and 1300 cannot communicate with each other and the communication terminals 1300 and 1400 cannot communicate with each other just after the management terminal 1100 receives the communication availability judgment result (shown as “UNAVAILABLE” in the figure).

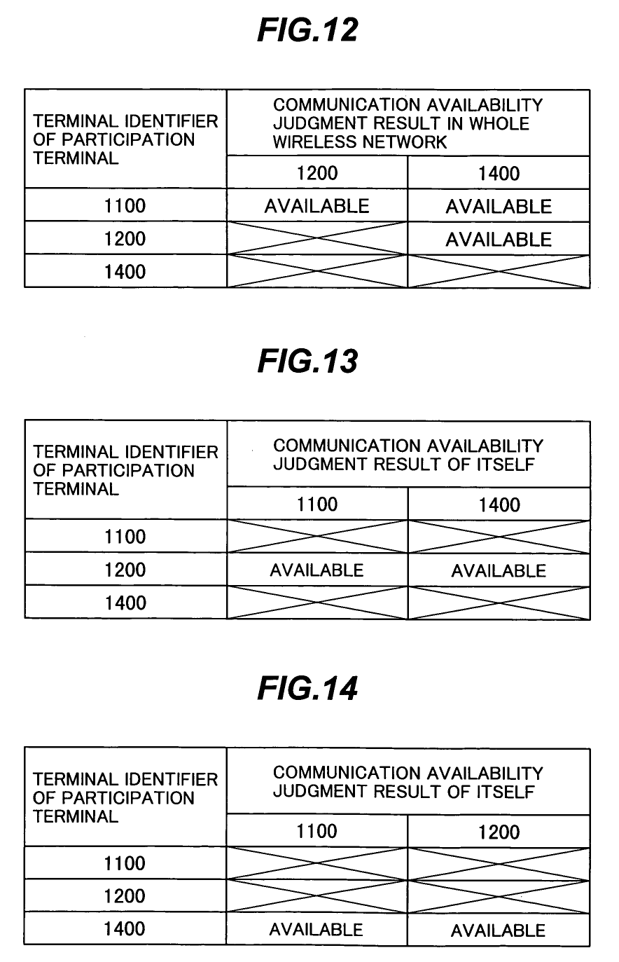

Next, a case where the management terminal 1100 excludes the communication terminal 1300 from the wireless network 1010 will be described in Step E. In this case, the configuration of the wireless network 1010 changes from the configuration shown in FIG. 6 to that shown in FIG. 11. As a result, the participation terminal information stored in the management terminal 1100 contains information regarding the communication terminals 1100, 1200 and 1400, as shown in FIG. 12. Further, in Step F, the process indicated in Step A is performed again and the communication terminal information stored in the participation terminals 1200 and 1400 are updated in such a way that the communication terminal information stored in the participation terminals 1200 and 1400 is changed to the states shown in FIG. 13 and FIG. 14, respectively.

The configuration of the wireless network 1010 is managed as has been described above, and thus communication reachability between all the communication terminals that are participating in the wireless network can be continuously ensured.

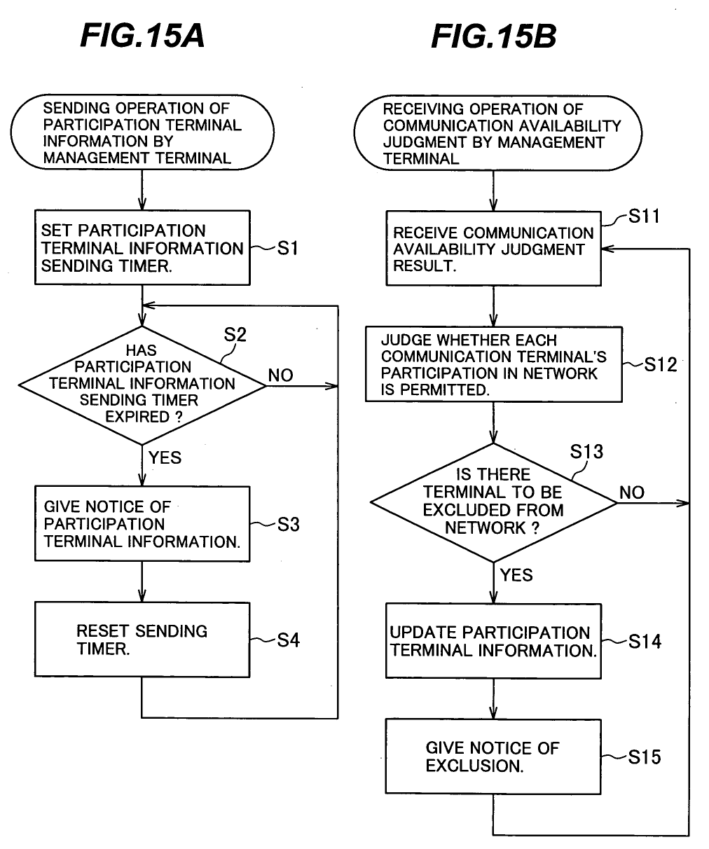

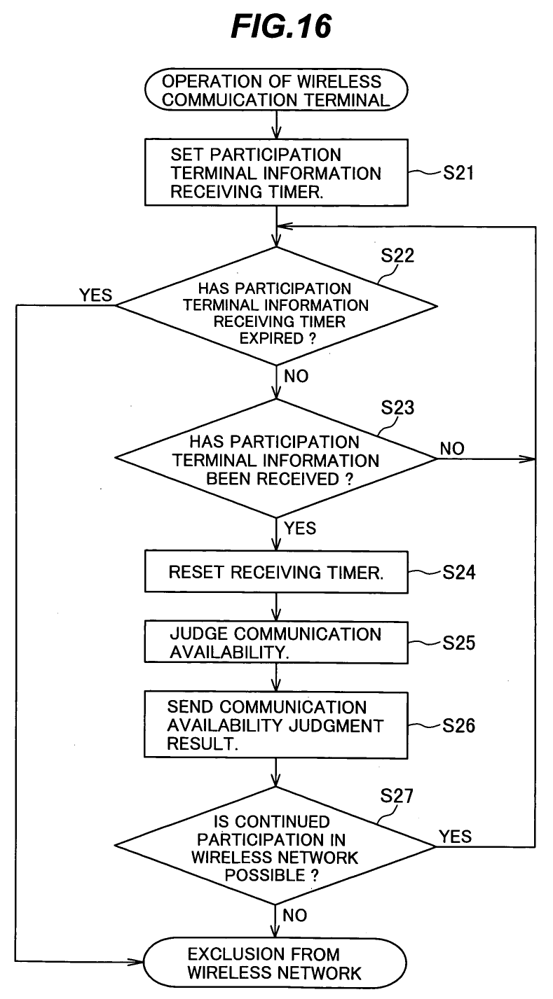

Next, the method of managing the wireless network 1010 according to the first embodiment will be described in detail. FIGS. 15A and 15B are flowcharts showing operations of the management terminal 1100. Further, FIG. 16 is a flowchart showing an operation of the communication terminals 1200, 1300 and 1400. As has already been described above, the management terminal 1100 has the participation terminal information including terminal information of the communication terminals that are participating in the wireless network 1010. In accordance with such participation terminal information, the management terminal 1100 and the communication terminals 1200, 1300 and 1400 can acquire which communication terminals are participating in the wireless network 1010.

First, with reference to FIG. 15A, the sending operation of the participation terminal information performed by the management terminal 1100 will be described. The management terminal 1100 sends the participation terminal information at regular intervals. The management terminal 1100 initially sets a participation terminal information sending timer (step S1), and determines whether the participation terminal information sending timer has expired or not (step S2). If the participation terminal information sending timer has not expired in step S2, the process returns to the beginning of step S2 again, the management terminal 1100 is brought to a state of waiting for the sending operation of the participation terminal information. If the participation terminal information sending timer has expired in step S2, the management terminal 1100 broadcasts the participation terminal information stored in itself to the communication terminals 1200, 1300 and 1400 which form the wireless network 1010 (step S3) and resets the participation terminal information sending timer (step S4). Then, the management terminal 1100 repeatedly sends the participation terminal information at regular intervals (steps S2 to S4).

Next, the receiving operation of the communication availability judgment result by the management terminal 1100 will be described with reference to FIG. 15B. The management terminal 1100 receives the communication availability judgment result from the communication terminals 1200, 1300 and 1400 (step S11). The communication availability judgment result is obtained by confirming whether or not each of the communication terminals 1200, 1300 and 1400 can directly communicate with all the other communication terminals, which are participating in the wireless network 1010. The communication availability judgment result indicates a communication terminal which can communicate with each of the communication terminals 1200, 1300 and 1400 itself and another communication terminal which cannot communicate with each of the communication terminals 1200, 1300 and 1400 itself. Using the received communication availability judgment result, the management terminal 1100 judges which communication terminals can continue participating in the wireless network 1010 (step S12), and determines whether there is a communication terminal that should be excluded from the wireless network 1010 or not (step S13). There are various kinds of ways to determine which communication terminal is excluded from the wireless network 1010 using the communication availability judgment result. For example, priority is provided in advance to each of the communication terminals, if there is a communication terminal which cannot communicate as a result of communication availability judgment result, a communication terminal is excluded in ascending order of the priority, and thus the communication terminal that should be excluded can be determined. By using one or more communication availability judgment result received within a predetermined period, a communication terminal that should be excluded can be also determined so that the maximum number of the communication terminals can continue participating in the wireless network.

When there is no communication terminal that should be excluded from the wireless network 1010, the management terminal 1100 returns to a state of receiving the communication availability judgment result. When there is a communication terminal that should be excluded from the wireless network 1010, the management terminal 1100 deletes the terminal information of the communication terminal that should be excluded from the participation terminal information stored in itself to update the participation terminal information (step S14), and sends a notice of exclusion to the communication terminal excluded from the wireless network 1010 (step S15). Then, the management terminal 1100 returns to a state of receiving the communication availability judgment result (step S11).

As has been described above, when the management terminal 1100 updates the participation terminal information, the updated participation terminal information is sent from the management terminal 1100 to each of the communication terminals 1200, 1300 and 1400 at regular intervals. Accordingly, each of the communication terminals 1200, 1300 and 1400 can be informed that the wireless network 1010 is re-configured, by receiving the updated participation terminal information and confirming the updated participation terminal information. If the management terminal 1100 cannot communicate with a communication terminal and cannot receive communication availability judgment result from the communication terminal, the management terminal 1100 deletes the terminal information of the communication terminal from the participation terminal information to update the participation terminal information and thus can exclude the communication terminal from the wireless network 1010. When the communication terminal is deleted from the wireless network, the management terminal 1100 notifies a user of the excluded communication terminal, by means of, for example, displaying a terminal identifier of the excluded communication terminal on a liquid crystal display (LCD). Thus, the user can be informed of the excluded communication terminal and that the wireless network configuration has changed. The user can appropriately take an action, for example, by moving the excluded communication terminal to another place in which the communication terminal can communicate.

Next, operations of the communication terminals 1200, 1300 and 1400 forming the wireless network in the first embodiment will be described with reference to FIG. 16. The communication terminals 1200, 1300 and 1400 initially set participation terminal information receiving timers to determine whether they can receive the participation terminal information which is broadcasted from the management terminal 1100 at regular intervals or not (step S21), and then confirm whether the participation terminal information receiving timers have expired or not (step S22). If the timers have expired in step S22, the communication terminals 1200, 1300 and 1400 determine that they cannot communicate with the management terminal 1100 and cannot participate in the wireless network 1010. If the timers have not expired in step S22, the communication terminals 1200, 1300 and 1400 confirm whether they have received the participation terminal information sent from the management terminal 1100 or not (step S23). If the communication terminals have not received the participation terminal information, the communication terminals return to a state of confirming a participation terminal information receiving timer. If the communication terminals 1200, 1300 and 1400 receive the participation terminal information in step S23, the communication terminals 1200, 1300 and 1400 reset the participation terminal information receiving timers (step S24), confirm whether or not they can directly communicate with the other communication terminals, which are participating in the wireless network, in accordance with terminal information of the participation terminal information, and judge availability of communication with each of the communication terminals (step S25). For judging the communication availability between each of the communication terminals, for example, it can be judged that communication terminals can communicate with each other if communication between the communication terminals is successfully performed. The communication terminals 1200, 1300 and 1400 perform the communication availability judgment with each of the communication terminals that are participating in the wireless network 1010. Thereafter, in accordance with a judgment result, the communication terminals 1200, 1300 and 1400 send to the management terminal 1100 the communication availability judgment result indicating which communication terminal they can currently communicate with (step S26).

Further, after sending the communication availability judgment result to the management terminal 1100, the communication terminals 1200, 1300 and 1400 confirm whether a notice of exclusion from the management terminal 1100 has been received or not, and determine whether their own communication terminals can continue participating in the wireless network or not (step S27). If the communication terminals 1200, 1300 and 1400 judge that their own communication terminals are excluded from the wireless network 1010, the communication terminals 1200, 1300 and 1400 notify a user that their own communication terminals are excluded from the wireless network 1010, for example, by blinking a red lamp of an LED or the like. The user can be informed of the exclusion of the communication terminals and can take an appropriate measure for the excluded communication terminals, i.e., moving the terminals to another place, for example. If the communication terminals 1200, 1300 and 1400 do not receive the notice of exclusion from the management terminal 1100 and accordingly determine that their own communication terminals can continue participating in the wireless network 1010, the communication terminals 1200, 1300 and 1400 return to a state of waiting for termination of the participation terminal information receiving timer (step S22).

As has been described above, according to the first embodiment, the communication terminals forming the wireless network can be managed and the wireless network can be realized so that all the communication terminals that are participating in the wireless network can directly communicate with each other, even if communication becomes impossible due to a change in the communication condition between the communication terminals, by excluding the participation terminal. Further, each of the communication terminals can be immediately notified which the participation terminal is excluded from the network, by sending a notice of exclusion for notifying that the participation terminal that should be excluded is excluded from the network to the terminal that should be excluded. Furthermore, it can be kept the participation terminal information updated to the newest one by repeating the judgment in Step C at regular intervals. Moreover, when the participation terminal excluded from the network displays a notification for the user that the terminal has been excluded from the network, the user can immediately address the exclusion from the network (for example, moving the terminal to another place).

### Second Embodiment

A network configuration management method according to the second embodiment of the present invention differs from the network configuration management method according to the above-described first embodiment in a point that the notice of exclusion, which is described in Step E of the above-described first embodiment, is not sent from the management terminal 1100.

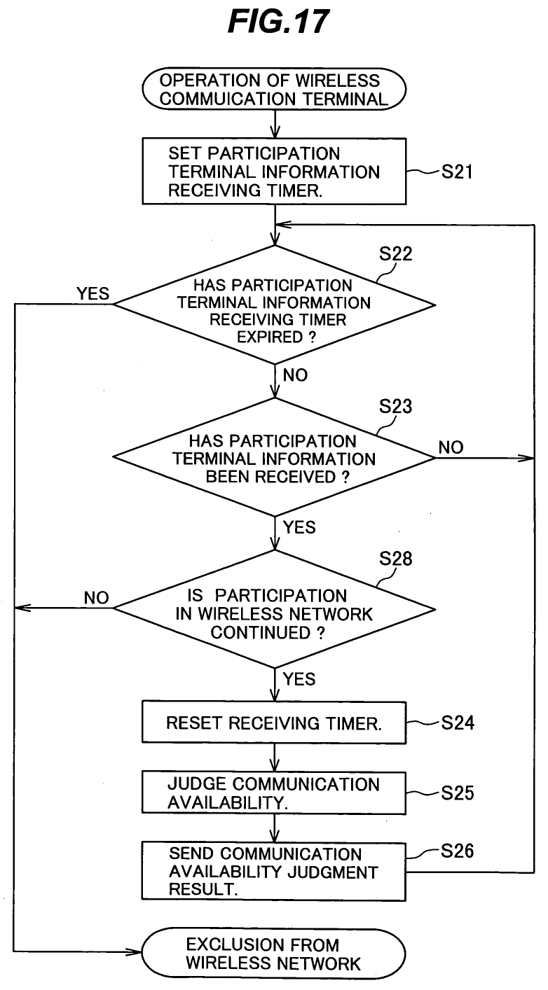

FIG. 17 is a flowchart showing an operation of a communication terminal in the second embodiment of the present invention. The operations of the communication terminals 1200, 1300 and 1400 forming the wireless network 1010 in the second embodiment will be described with reference to FIG. 17. The processes of steps S21 to S23 in FIG. 17 is substantially the same as the processes of steps S21 to S23 in FIG. 16 (the first embodiment). In step S23, the communication terminals 1200, 1300 and 1400 receive the participation terminal information sent from the management terminal 1100 and confirm whether the received participation terminal information contains their own terminal information or not. If their own terminal information is contained in the received participation terminal information, the communication terminals determine that their own communication terminals can continue participating in the wireless network 1010. If their own terminal information is not contained in the received participation terminal information, the communication terminals determine that their own communication terminals can no longer participate in the wireless network 1010 (step S28). In accordance with the communication availability judgment result received from each of the communication terminals 1200, 1300 and 1400, the management terminal 1100 deletes the terminal information of a communication terminal that should be excluded from the wireless network 1010 to update the participation terminal information. For this reason, it can be determined whether its own communication terminal is participating in the wireless network 1010 or its own communication terminal has been excluded from the wireless network 1010 by confirming the participation terminal information.

If their own communication terminals can continue participating in the wireless network 1010, the communication terminals 1200, 1300 and 1400 reset the receiving timer (step S24), perform the communication availability judgment (step S25), send the communication availability judgment result to the management terminal 1100 (step S26), and return to a state of waiting for termination of the participation terminal information receiving timer (step S22) in substantially the same manner as the first embodiment.

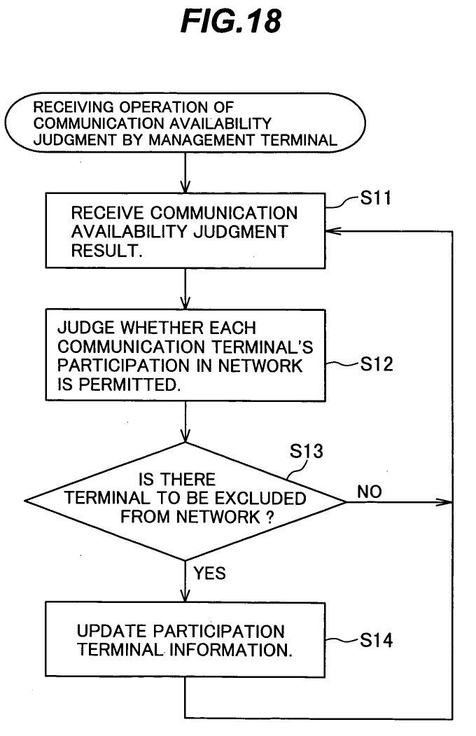

FIG. 18 is a flowchart showing an operation of the management terminal in the second embodiment of the present invention. The receiving operation of the communication availability judgment result by the management terminal 1100 which forms the wireless network 1010 in the second embodiment will be described with reference to FIG. 18. The sending operation of the participation terminal information by the management terminal 1100 in the second embodiment is substantially the same as that in the first embodiment (the operation shown in FIG. 15A). As shown in FIG. 18, the receiving operation of the communication availability judgment result by the management terminal 1100 in the second embodiment differs from that in the above-described first embodiment (the operation shown in FIG. 15B) in a point that the sending of the notice of exclusion to a communication terminal excluded from the wireless network 1010 (step S15) is eliminated. The receiving operation of the communication availability judgment result of the management terminal 1100 in steps S11 to S14 in the second embodiment are substantially the same as the receiving operation of the communication availability judgment result in the first embodiment. In the second embodiment, as shown in FIG. 18, after step S14 at which the participation terminal information is updated, the management terminal returns to a state of receiving the communication availability judgment result (step S11).

As has been described above, in the second embodiment, the communication terminals 1200, 1300 and 1400 determine whether their own communication terminals can continue participating in the wireless network 1010 or their own communication terminals are excluded from the wireless network 1010, by confirming the participation terminal information which is sent from the management terminal 1100. For this reason, when the management terminal 1100 excludes a communication terminal from the wireless network 1010, the management terminal 1100 can exclude the communication terminal from the wireless network 1010 without sending the notice of exclusion from the wireless network 1010 to the communication terminal.

As has been described above, according to the second embodiment, the communication terminals forming the wireless network can be managed and the wireless network can be realized so that all the communication terminals that are participating in the wireless network can directly communicate with each other, even if communication becomes impossible due to a change in the communication condition between the communication terminals, by excluding a participation terminal. Except for the points described above, the second embodiment is substantially the same as the first embodiment.

### Third Embodiment

In a network configuration management method according to the third embodiment of the present invention, the judgment in Step C in the first or second embodiment is performed as follows. First, a participation terminal other than the management terminal 1100 sends data for communication availability judgment at regular intervals to all the other participation terminals, which are participating in the wireless network 1010, and then a participation terminal which has received the data for communication availability judgment judges whether communication can be performed or not in accordance with the received data for communication availability judgment.

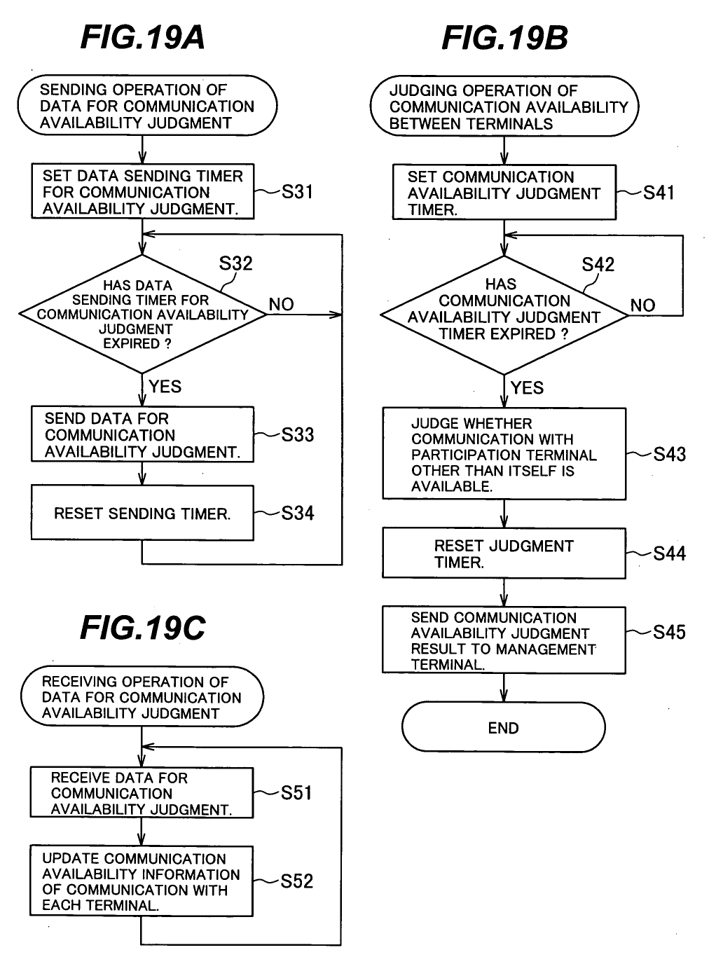

FIGS. 19A to 19C are flowcharts showing operations of a communication terminal other than the management terminal in the third embodiment of the present invention. Further, FIG. 19A shows the sending operation of the data for communication availability judgment, FIG. 19B shows the communication availability judging operation, and FIG. 19C shows the receiving operation of the data for communication availability judgment. The operation of the communication terminal which forms a wireless network in the third embodiment will be described with reference to FIGS. 19A to 19C. The operations of the management terminal 1100 in the third embodiment are substantially the same as those of the management terminal in the first or second embodiment.

In the network configuration management method according to the third embodiment, the communication availability judging step in the communication terminal is different from the communication availability judging step (step S25) described in the first or second embodiment shown in FIG. 16 or FIG. 17. The network configuration management method according to the third embodiment corresponds to a method in which the processes shown in FIGS. 19A to 19C are used as a substitute for the communication availability judging step (step S25) of the first or second embodiment shown in FIG. 16 or FIG. 17. For this reason, regarding the third embodiment, only operation of judging the communication availability with the other communication terminals, which are participating in the wireless network 1010, will be described.

First of all, the data for communication availability judgment used in the communication availability judging operation in the third embodiment will be described. The data for communication availability judgment contains a terminal identifier of each of the communication terminals. Each of the communication terminals 1200, 1300 and 1400 that are participating in the wireless network 1010 sends the data for communication availability judgment with its own terminal identifier by broadcasting at regular intervals, so that each of the communication terminals can confirm that it can communicate with the other communication terminals, which are participating in the wireless network 1010.

The sending operation of the data for communication availability judgment will be first described with reference to FIG. 19A. The communication terminals 1200, 1300 and 1400 set a data sending timer for communication availability judgment (step S31) in order to send the data for communication availability judgment at predetermined intervals. Subsequently, the communication terminals 1200, 1300 and 1400 determine whether the data sending timer for communication availability judgment has expired or not (step S32). If the data sending timer for communication availability judgment has expired, the communication terminals 1200, 1300 and 1400 send the data for communication availability judgment with their own terminal identifiers (step S33) and reset the data sending timer for communication availability judgment (step S34). If the data sending timer for communication availability judgment has not expired, the communication terminals 1200, 1300 and 1400 return to a state of waiting for the sending of data for communication availability judgment.

Next, the receiving operation of the data for communication availability judgment will be described with reference to FIG. 19C. The communication terminals 1200, 1300 and 1400 receive, whenever necessary, the data for communication availability judgment sent at regular intervals from the other communication terminals, which are participating in the wireless network 1010 (step S51). In accordance with the terminal identifier contained in the received data for communication availability judgment, the communication terminals 1200, 1300 and 1400 specify which communication terminals the received data is sent from. Then, the communication terminals 1200, 1300 and 1400 can determine that they can communicate with the communication terminal from which the received data is sent, and accordingly updates the communication availability information regarding the communication terminal (step S52). The communication terminals 1200, 1300 and 1400 perform the receiving operation and update the communication availability information whenever they receive the data for communication availability judgment from the other communication terminals. In order to update the communication availability information, for example, the communication terminals 1200, 1300 and 1400 may use the latest receiving time of the data for communication availability judgment received from each of the communication terminals as the communication availability information and the communication terminals 1200, 1300 and 1400 accordingly update the receiving time of the data for communication availability judgment of the communication terminal whenever the communication terminals 1200, 1300 and 1400 receive the data for communication availability judgment from each of the communication terminals.

Next, the communication availability judging operation will be described with reference to FIG. 19B. The communication terminals 1200, 1300 and 1400 set respective timers for communication availability judgment (step S41) and then determine whether the timers for communication availability judgment have expired or not (step S42). If the timers for communication availability judgment have not expired, the communication terminals 1200, 1300 and 1400 return to a state of waiting for termination of the timer for communication availability judgment. If the timers for communication availability judgment have expired, the communication terminals 1200, 1300 and 1400 confirm the communication availability information regarding all the communication terminals which are currently participating in the wireless network, perform the communication availability judgment with each of the communication terminals (step S43), and reset the timer for communication availability judgment (step S44). After that, in accordance with the communication availability judgment result, the communication terminals 1200, 1300 and 1400 send the communication availability judgment result to the management terminal 1100 (step S45), in substantially the same manner as those in the first embodiment. By using the latest receiving time of the data for communication availability judgment received from each of the communication terminals, as an example of the communication availability information, the communication terminals 1200, 1300 and 1400 compare the latest receiving time received from each of the communication terminals with the current time, and confirm whether it is received within a predetermined time or not. If the confirmation result is received within the predetermined time, the communication terminals 1200, 1300 and 1400 determine that they can communicate with the communication terminal. If the confirmation result is not received within the predetermined time, the communication terminals 1200, 1300 and 1400 determine that they cannot communicate with the communication terminal. Each of the communication terminals 1200, 1300 and 1400 can thus perform the communication availability judgment.

As has been described above, all the communication terminals 1200, 1300 and 1400 other than the management terminal 1100, which are participating in the wireless network 1010, perform the sending operation of the data for communication availability judgment and the communication availability judgment operation, so that communication availability between all the participation terminals can be confirmed. As the communication availability judgment is thus performed, the communication terminals forming the wireless network 1010 can be managed and a wireless network can be formed so that all the communication terminals that are participating in the wireless network can directly communicate with each other by deleting a participation terminal, even if communication becomes impossible due to a change in the communication condition between each of the communication terminals. Except for the points described above, the third embodiment is substantially the same as the first or second embodiment.

### MODIFIED EXAMPLES OF FIRST TO THIRD EMBODIMENTS

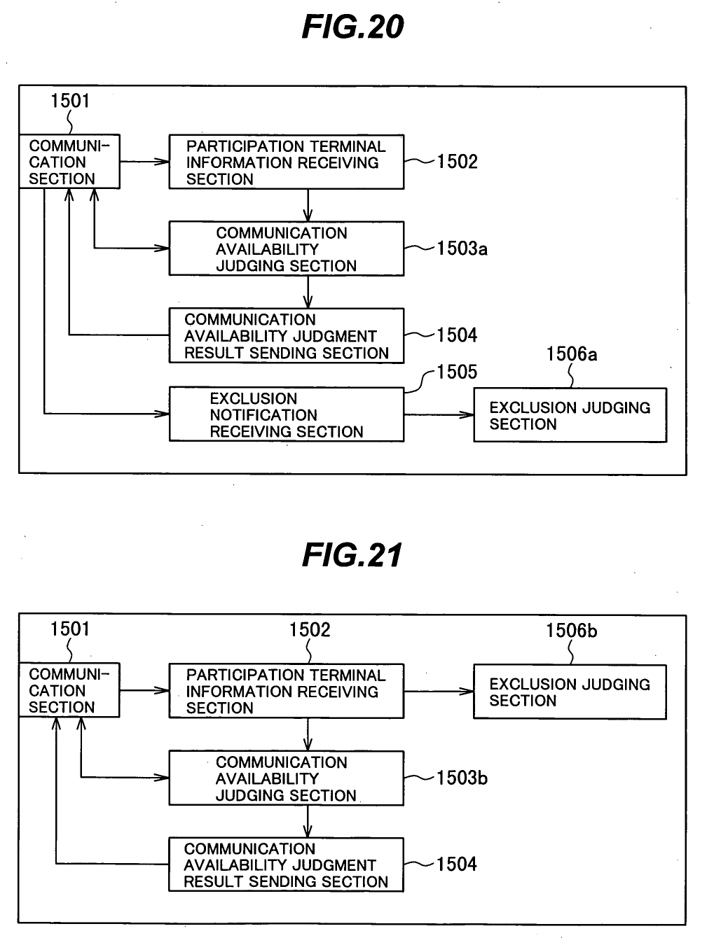

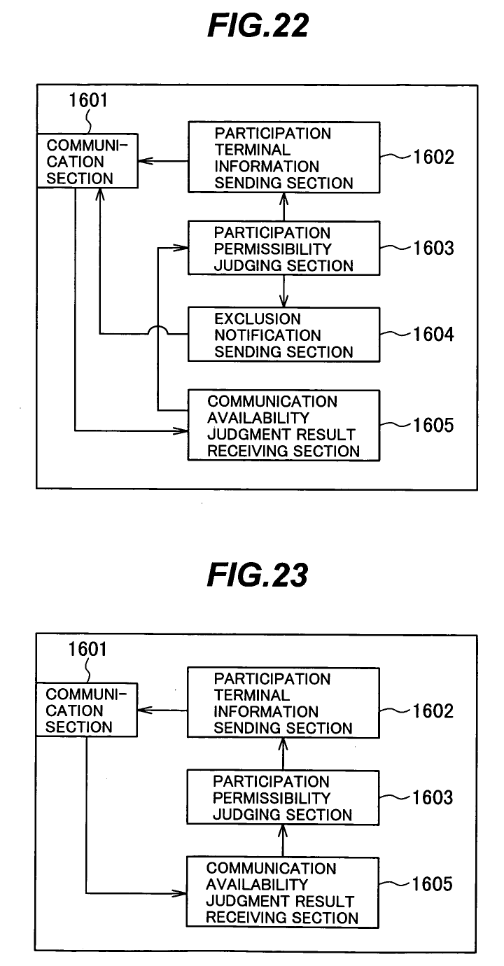

Although the above-described first to third embodiments show examples of performing the network configuration management method by software, it is also available that the communication terminals have hardware (H/W) configurations shown in FIG. 20 to FIG. 23 in order to have the functions described in the first to third embodiments. FIG. 20 is a diagram showing a configuration of a modified example of the communication terminals 1200, 1300 and 1400 in the first embodiment. The communication terminal of FIG. 20 includes a communication section 1501, a participation terminal information receiving section 1502, a communication availability judging section 1503a, a communication availability judgment result sending section 1504, an exclusion notification receiving section 1505, and an exclusion judging section 1506a. Further, FIG. 21 is a diagram showing a configuration of a modified example of the communication terminals 1200, 1300 and 1400 in the second embodiment. The communication terminal of FIG. 21 includes a communication section 1501, a participation terminal information receiving section 1502, a communication availability judging section 1503b, a communication availability judgment result sending section 1504, and an exclusion judging section 1506b. Furthermore, FIG. 22 is a diagram showing a configuration of a modified example of the management terminal 1100 in the first embodiment. The management terminal of FIG. 22 includes a communication section 1601, a participation terminal information sending section 1602, a participation permissibility judging section 1603, an exclusion notification sending section 1604, and a communication availability judging result receiving section 1605. Moreover, FIG. 23 is a diagram showing a configuration of a modified example of the management terminal 1100 in the second embodiment. The management terminal of FIG. 23 includes a communication section 1601, a participation terminal information sending section 1602, the participation permissibility judging section 1603, and the communication availability judgment result receiving section 1605.

### Fourth Embodiment

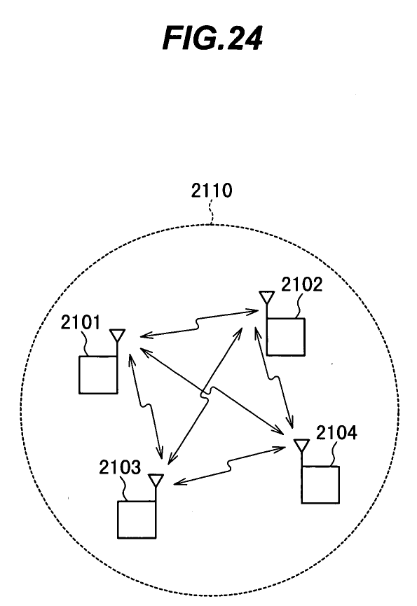

A method of managing a network band according to the fourth embodiment of the present invention will be described with reference to the drawings. FIG. 24 is a diagram showing a configuration of a wireless network 2110 of the present invention. As shown in FIG. 24, the network 2110 is configured so that all terminals forming the network 2110 directly communicate with each other without an access point. In FIG. 24, the terminals 2101 to 2104 for the wireless communication form the network 2110. Solid double-headed arrows in FIG. 24 indicate that the terminals 2101 to 2104 can directly communicate with each other. Further, the network 2110 has a single management terminal. The management terminal acquires the terminals that are participating in the network 2110 and a communication band which is used in the network 2110, and the management terminal notifies the managed terminals of the acquired information. In the following description, it is assumed that the terminal 2101 is a management terminal and the terminals 2102 to 2104 are the managed terminals. Although the fourth embodiment is an example in the case of IEEE 802.11a, the present invention is not limited to this example. In the description, physical speed of the line is referred to as a transmission rate, and substantial data amount which can be sent over a line in unit time (except for additional data such as a header) is referred to as a band. Further, regarding calculations in the fourth and fifth embodiments, figures below the second decimal place are omitted.

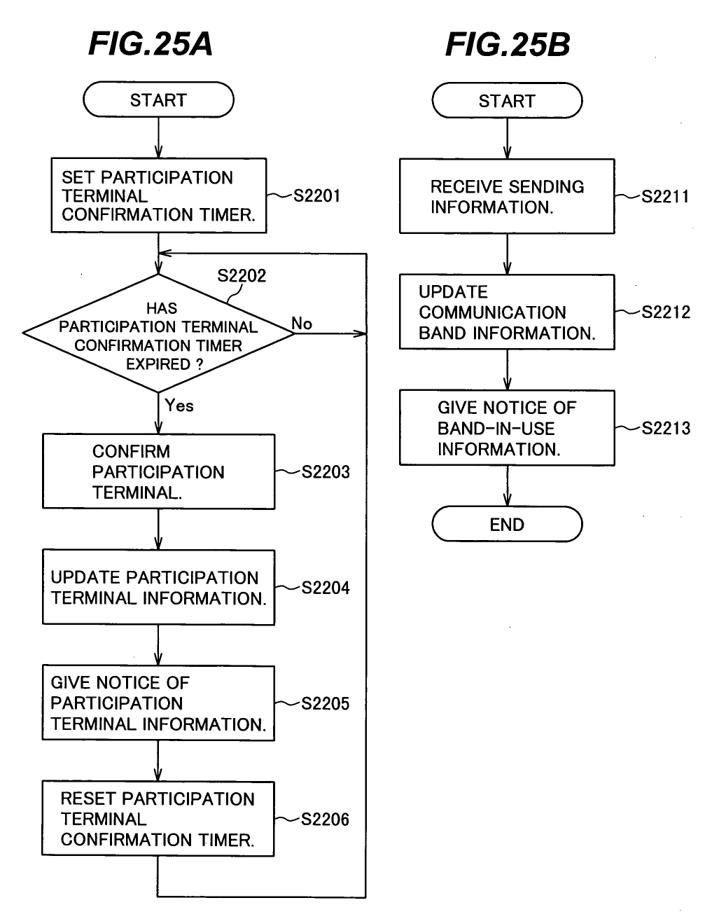

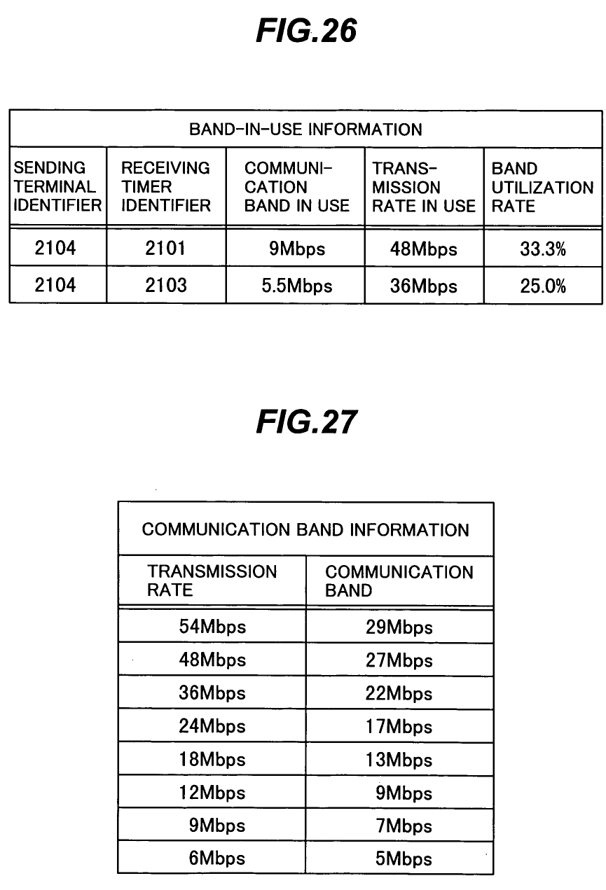

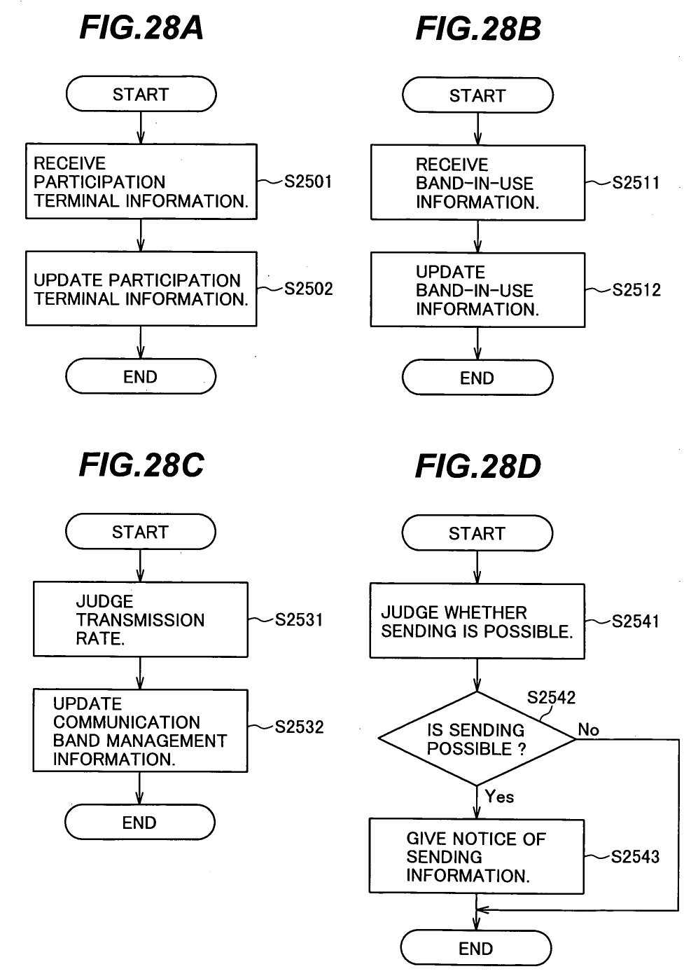

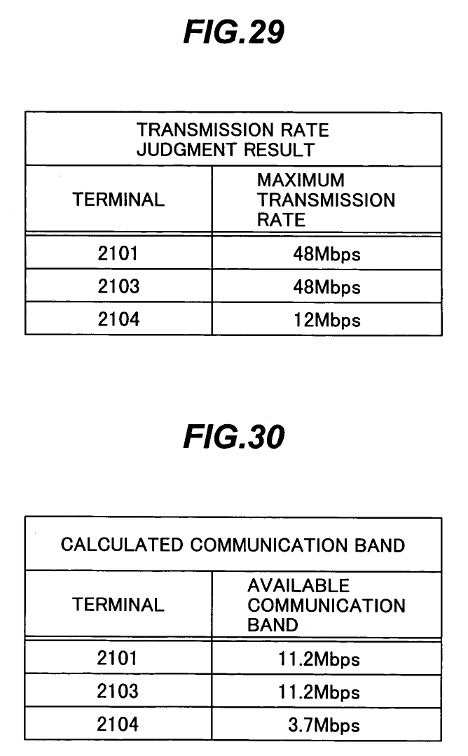

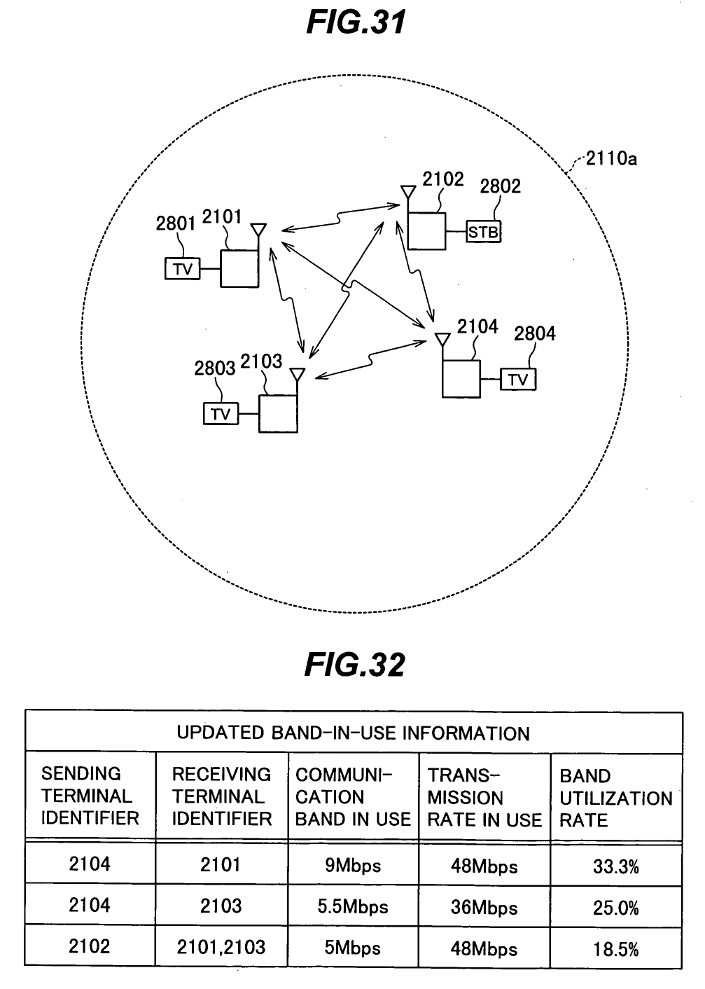

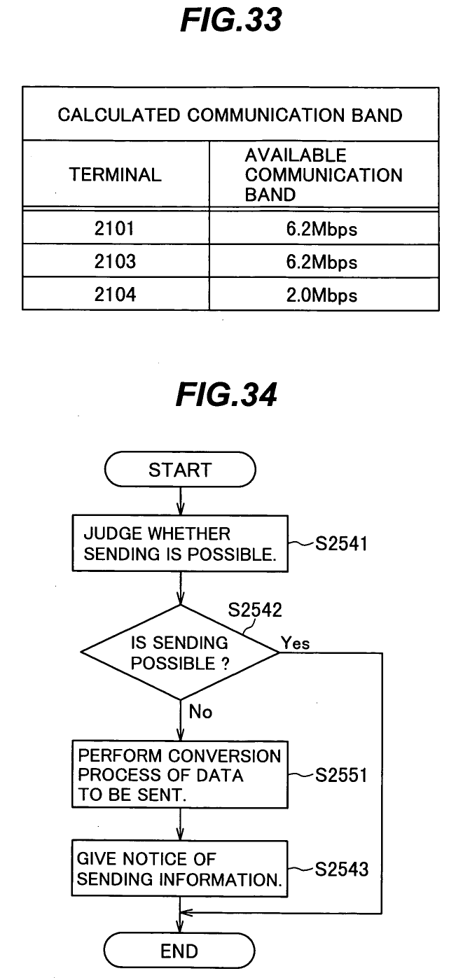

The fourth embodiment will be described below with reference to FIG. 24 to FIG. 33. FIGS. 25A and 25B are flowcharts showing operations of the management terminal 2101. FIG. 26 and FIG. 32 show an example of band-in-use information generated by the terminal 2101. The band-in-use information indicates use of the communication band in the network 2110 and contains a sending terminal identifier, a receiving terminal identifier, a communication band in use, a transmission rate in use, and a band utilization rate. FIG. 27 is a diagram showing transmission rates in IEEE 802.11a and an example of the communication bands available for the transmission rates in the network 2110. FIGS. 28A to 28D are flowcharts showing operations of the managed terminals 2102 to 2104. FIG. 29 is a diagram showing an example of the maximum transmission rates which are available in communication between the terminal 2102 and the terminals 2101, 2103 and 2104, respectively. FIG. 30 and FIG. 33 show an example of the communication bands which are available in communication between the terminal 2102 and the terminals 2101, 2103 and 2104, respectively. FIG. 31 is a diagram showing a configuration of the network 2110a when the AV (audio visual) equipments are connected to the terminals 2101 to 2104.

The network band managing operation of the management terminal 2101 will be described with reference to FIGS. 25A and 25B. The management terminal 2101 holds the participation terminal information from the terminal information of the terminals 2101 to 2104 that are participating in the network 2110. As described below, the terminals 2101 to 2104 can acquire participation terminals to the network 2110 in accordance with the participation terminal information.

First, with reference to FIG. 25A, the participation terminal information giving notice of operation of the terminal 2101 will be described. The management terminal 2101 confirms the participation terminal information at predetermined intervals, as follows. In step S2201, the management terminal 2101 sets a participation terminal confirmation timer. Then, the process goes to step S2202, the management terminal 2101 confirms whether the participation terminal confirmation timer has expired or not. If the participation terminal confirmation timer has not expired, the management terminal 2101 repeats step S2202 until the participation terminal confirmation timer expires. If the participation terminal confirmation timer has expired, the process goes to step S2203 and the management terminal 2101 confirms the terminals (hereinafter, referred to as participation terminals) 2102 to 2104 that are participating in the network 2110. The participation terminals can be confirmed, for example, in a way that confirmation data is broadcasted to the participation terminals and the participation terminals send confirmation responses to the management terminal 2101 corresponding to the confirmation data. Next, the process goes to step S2204 and the management terminal 2101 updates the participation terminal information which is stored in itself, in accordance with the confirmation result in step S2203. Next, the process goes to step S2205 and the management terminal 2101 broadcasts the participation terminal information to each of the participation terminals. Then, the process goes to step S2206 and the management terminal 2101 resets the participation terminal information confirmation timer. Subsequently, the process goes to step S2202 again and the management terminal 2101 returns to a state of waiting for participation terminal confirmation.

Besides the method described above, the participation terminals can be confirmed by a method in which the participation terminals send the confirmation information indicating whether or not the participation terminals participate in the network to the management terminal 2101 at regular intervals, and so forth.

Next, a notifying operation of the band in use of the management terminal 2101 will be described with reference to FIG. 25B. In step S2211, the management terminal 2101 receives the sending information from the terminals 2102 to 2104. The sending information contains a sending terminal identifier, a receiving terminal identifier, a communication band in use, and a transmission rate in use. As described below, each of the terminals 2102 to 2104 gives notice of (or sends) the sending information to the management terminal 2101 as information regarding the band that its own terminal uses for data transmission. Next, the process goes to step S2212 and the management terminal 2101 generates and updates the band-in-use information regarding the band which is used in the network 2110 in accordance with the received sending information. An example of the band-in-use information is shown in FIG. 26. As shown in FIG. 26, the terminal 2104 communicates with the management terminal 2101 by using 9 Mbps of communication band in 48 Mbps of transmission rate. On the other hand, the terminal 2104 communicates with the terminal 2103 by using 5.5 Mbps of communication band in 36 Mbps of transmission rate. In step S2212, in accordance with the transmission rates and the upper limit of the communication band shown in FIG. 27, how much the communication band is used is calculated.

In other words, the transmission rate for the transmission from the terminal 2104 to the terminal 2101 is 48 Mbps as shown in FIG. 26, and the upper limit of the communication band is 27 Mbps which corresponds to 48 Mbps of the transmission rate as shown in FIG. 27. Accordingly, the communication from the terminal 2104 to the management terminal 2101 uses 33.3% (=9 Mbps/27 Mbps) of the communication band for the network 2110.

Similarly, the transmission rate for the transmission from the terminal 2104 to the terminal 2103 is 36 Mbps as shown in FIG. 26, and the communication band corresponding to the transmission rate of 36 Mbps is 22 Mbps as shown in FIG. 27. Accordingly, the communication from the terminal 2104 to the terminal 2103 uses 25.0% (=5.5 Mbps/22 Mbps) of the communication band for the network 2110.

Thus, 41.7% (=100%−(33.3%+25.0%)) of the communication band for the network 2110 are available for other communication.

Then, the process goes to step S2213 and the management terminal 2101 notifies the terminals 2102 to 2104 of the band-in-use information updated in step S2212. The notification of the band-in-use information is performed, for example, in substantially the same manner as the notification of the participation terminal information in step S2205 described above, to the terminals 2102 to 2104 that are participating in the network 2110 at regular intervals. The terminals 2102 to 2104 can thus acquire the band in use in the network 2110 at regular intervals. Or, when one of the terminals 2102 to 2104 generates a notification request of data, the management terminal 2101 may give notice of the band-in-use information to the terminal which generates the notification request or all of the terminals 2102 to 2104 that are participating in the network 2110. By adopting the above operation, the management terminal 2101 does not send the band-in-use information unless the notification request is newly generated, and therefore communication traffic in the network 2110 can be minimized.

Next, operations of the terminals 2102 to 2104 will be described with reference to FIGS. 28A to 28D.

First, the receiving operation of the participation terminal information by the terminals 2102 to 2104 will be described with reference to FIG. 28A. In step S2501, each of the terminals 2102 to 2104 receives the participation terminal information which is sent from the terminal 2101 at regular intervals. Subsequently, the process goes to step S2502 and each of the terminals 2102 to 2104 updates the participation terminal information stored in its own terminal in accordance with the received information in step S2501.

Next, the receiving operation of the band-in-use information by the terminals 2102 to 2104 will be described with reference to FIG. 28B. In step S2511, each of the terminals 2102 to 2104 receives the band-in-use information from the terminal 2101. Subsequently, the process goes to step S2512 and each of the terminals 2102 to 2104 updates the band-in-use information stored in its own terminal in accordance with the received information in step S2511.

Next, the managing operation of the communication band by the terminals 2102 to 2104 will be described with reference to FIG. 28C. In step S2531, each of the terminals 2102 to 2104 judges the maximum available transmission rate for communication with each of the other terminals, which are participating in the network 2110 in accordance with the received participation terminal information, when each of the terminals 2102 to 2104 receives the participation terminal information notified from the terminal 2101, for example. For the transmission rate judgment, for example, a terminal performs communication with another terminal once or more from at 54 Mbps transmission rate in descending order. If the communication can be successfully performed a predetermined number of times or more, it is judged that the terminals can communicate with each other at the transmission rate. Next, the process goes to step S2532 and each of the terminals 2102 to 2104 updates the communication band management information, in accordance with the transmission rate judgment result described above and the band-in-use information. The communication band management information indicates a communication band in which a terminal can communicate with terminals other than its own terminal in the network 2110.

As an example, if a transmission rate judgment result between the terminal 2102 and each of the terminals 2101, 2103 and 2104 is as shown in FIG. 29, in accordance with the band-in-use information shown in FIG. 26 and the transmission rates shown in FIG. 27, the available communication bands between the terminal 2102 and each of the terminals 2101, 2103 and 2104 can be calculated as shown in FIG. 30.

That is, the transmission rate from the terminal 2102 to the terminals 2101 and 2103 is 48 Mbps as shown in FIG. 29 and the communication band corresponding 48 Mbps of transmission rate is 27 Mbps as shown in FIG. 27. Here, as has been described above with reference to FIG. 26, since 41.7% of communication band of the network 2110 can be used for other communication, the available communication band for the terminals 2101 and 2103 is 11.2 Mbps (=27 Mbps×0.417) as shown in FIG. 30.

Similarly, while the transmission rate from the terminal 2102 to the terminal 2104 is 12 Mbps as shown in FIG. 29, the communication band corresponding to the transmission rate 12 Mbps is 9 Mbps as shown in FIG. 27. Here, as has been described above, since 41.7% of communication band of the network 2110 can be used for other communication, an available communication band for the terminal 2104 is 3.7 Mbps (=9 Mbps×0.417) as shown in FIG. 30.

In accordance with the communication band thus calculated, the communication band management information is updated in step S2532.

Next, a data transmission operation of the terminal will be described with reference to FIG. 28D and FIG. 31. FIG. 31 is a diagram showing a configuration of the network 2110a, in which a TV 2801, a STB (set top box) 2802, a TV 2803, and a TV 2804 are connected to each of the terminals 2101 to 2104 in the network 2110 of FIG. 24. Although FIG. 31 shows an example that the TV 2801 is connected to the network 2110a through the management terminal 2101, the same effect can be obtained when the TV 2801 having the same function of a wireless communication terminal as that of the terminal 2101 is directly connected to the network 2110a without the management terminal. This modification can be applied to the connections of the terminal 2102 and the STB 2802, the terminal 2103 and the TV 2803, and the terminal 2104 and the TV 2804.

Operations when the STB 2802 provides the TVs 2801, 2803 and 2804 with stream data which consist of motion pictures, for example, will be described below. In this case, the terminal 2102 attempts to broadcast the stream data to the terminals 2101, 2103 and 2104 in the network 2110a.

A data transmission operation of the terminal 2102 will be described with reference to FIG. 28D. As shown in FIG. 28D, in step S2541, in accordance with a request from the STB 2802, the terminal 2102 refers to the communication band management information described above and compares the communication band management information with a communication band that the terminal needs for data transmission to judge whether the sending is possible or not.

For example, in the case where the communication band management information is as shown in FIG. 30, when the terminal 2102 attempts to send 5 Mbps stream data, since 5 Mbps is smaller than an available communication band shown in FIG. 30, i.e., 5 Mbps<11.2 Mbps, as a sending judgment result, it is determined that the sending at the transmission rate of 48 Mbps can be performed to the terminals 2101 and 2103. Further, since 5 Mbps is larger than the available communication band shown in FIG. 30, i.e., 5 Mbps>3.7 Mbps, as the sending judgment result, the terminal 2102 determines that the sending cannot be performed to the terminal 2104.

As a result of the sending possibility judgment in step S2541, if it is determined that the sending can be performed, the process goes from step S2542 to step S2543, and the terminal 2102 sends to the management terminal 2101 the sending information which contains a sending terminal identifier, a receiving terminal identifier, a communication band in use, and a transmission rate in use. In the above case, the terminal 2102 sends to the management terminal 2101 the sending information indicating that the sending terminal identifier indicates the terminal 2102, the receiving terminal identifiers indicate the terminals 2101 and 2103, the communication band in use is 5 Mbps, and the transmission rate in use is 48 Mbps.

When receiving the sending information from the terminal 2102, the management terminal 2101 updates the band-in-use information as shown in FIG. 32 and sends the updated band-in-use information to each of the terminals in the network 2110a, in accordance with the operation described above. The terminal 2102 receives the band-in-use information shown in FIG. 32 and calculates the available communication band as shown in FIG. 33, in accordance with the band-in-use receiving operation of FIG. 28B and the communication band managing operation of FIG. 28C.

That is, although the transmission rate for the transmission from the terminal 2102 to the terminals 2101 and 2103 is 48 Mbps as shown in FIG. 29, the communication band corresponding to the transmission rate 48 Mbps is 27 Mbps as shown in FIG. 27. For this reason, when the terminal 2102 multicasts the 5 Mbps stream data to the terminals 2101 and 2103, 18.5% (=5 Mbps/27 Mbps) of communication band of the network 2110 is utilized. Accordingly, since 23.2% (=100%−(33.3%+25.0%+18.5%)) of communication band of the network 2110 can be used for other communication, an available communication band to the terminals 2101 and 2103 is 6.2 Mbps (=27 Mbps×0.232) as shown in FIG. 33.

Similarly, the transmission rate for the transmission from the terminal 2102 to the terminal 2104 is 12 Mbps as shown in FIG. 29 and the communication band corresponding to the 12 Mbps transmission rate is 9 Mbps as shown in FIG. 27. Here, as has been described above, since 23.2% of communication band of the network 2110 can be used for other communication, the available communication band to the terminal 2104 is 2.0 Mbps (=9 Mbps×0.232) as shown in FIG. 33.

As a result of the sending judgment in step S2541, if it is determined that the sending cannot be performed, a user is notified that the sending process is not carried out and the sending cannot be performed, for example, by blinking a red lamp of an LED or the like. Thus being informed that the terminal 2102 failed to broadcast the stream data to the terminal 2104, the user can send the stream data which is converted to 2.0 Mbps and can be sent to the terminal 2104 in accordance with the available communication band in FIG. 33, by using a means described below in the fifth embodiment, for example.

The sending operation of the 3 Mbps stream data from the STB 2802 to the TVs 2801, 2803 and 2804 will be described, considered when communication band management information is as shown in FIG. 30, for example. When the terminal 2102 attempts to broadcast the 3 Mbps stream data, it is determined that sending at transmission rate of 12 Mbps to the terminals 2101, 2103 and 2104 can be performed, in accordance with the transmission rate of the terminal 2104 shown in FIG. 29. The terminal 2102 sends to the terminal 2101 the sending information indicating that the sending terminal identifier indicates the terminal 2102, the receiving terminal identifiers indicate the terminals 2101, 2103 and 2104, the communication band in use is 3 Mbps, and the transmission rate in use is 12 Mbps.

As has been described above, in the network band management method of this embodiment, the terminals 2102 to 2104 notify the terminal 2101 of the sending information, and the band-in-use information which is generated on the basis of the sending information received by the terminal 2101 is notified to the terminals 2102 to 2104. For this reason, even if the transmission rate is changed, the communication band can appropriately be managed.

Further, in the fourth embodiment, since a network can be realized that wireless communication terminals can directly communicate with each other without an access point, a grater communication band can be utilized in comparison with a network using an access point for communication.

Furthermore, in the fourth embodiment, the networks 2110 and 2110a which use wireless system are described, however, the present invention is not limited to these examples. That is, even if the present invention is applied to a network such as a high-speed PLC (Power Line Communication) in which available transmission rates for communication with a terminal in the network changes due to a change in the communication condition between each terminals, the same effect can be obtained by performing the operations shown in FIG. 25A, FIG. 25B and FIGS. 28A to 28D.

Moreover, in the fourth embodiment, the terminal 2101 broadcasts the participation terminal confirmation data in order to confirm the terminals that are participating in the network 2110. The same effect can be obtained by using the unicast or the like, as a substitute for the broadcast.

In addition, in the fourth embodiment, for the transmission rate judgment, each of the terminals performs communication with a terminal in the network once or more from at 54 Mbps transmission rate in descending order of transmission rate for example. If the communication is successfully performed a predetermined number of times or more, it is determined that the communication can be performed at the transmission rate. However, the present invention is not limited to this example, and it is also available to communicate with a terminal in the network once or more from at 6 Mbps transmission rate in ascending order of transmission rate. If the communication can be successfully performed at a certain transmission rate a predetermined number of times or more, it is determined that the communication can be performed at the certain transmission rate.

### Fifth Embodiment

A network band management method according to the fifth embodiment of the present invention will be described with reference to FIG. 34. FIG. 34 is a flowchart showing a data transmission operation of the terminals 2102 to 2104 in the fifth embodiment. Except for the data transmission operations of the terminals 2102 to 2104, the operations in this embodiment are substantially the same as those in the fourth embodiment.

In the fifth embodiment, an operation by a STB 2802 when the 5 Mbps stream data is distributed to the TVs 2801, 2803 and 2804 in the wireless network 2110a shown in FIG. 31 will be described in the similar manner to the fourth embodiment. First, in accordance with a request from the STB 2802, in substantially the same manner as the fourth embodiment, the terminal 2102 performs the receiving operation of the participation terminal information shown in FIG. 28A, the receiving operation of the band-in-use information shown in FIG. 28B, and the managing operation of the communication band shown in FIG. 28C.

Next, in accordance with the request from STB 2802, the terminal 2102 performs the data transmission operation shown in FIG. 34. The data transmission operation in the fifth embodiment shown in FIG. 34 is different from the data transmission operation in the fourth embodiment shown in FIG. 28B, in the point that in the fifth embodiment, when the sending is determined to be impossible (step S2542), the sending data conversion process is performed (S2551), and then the sending information notification operation is performed (step S2543), on the other hand, in the fourth embodiment, when the sending is determined to be impossible (step S2542), the sending information notification operation is performed (step S2543).

In the fifth embodiment, in substantially the same manner as the fourth embodiment, when the terminal 2102 attempts to send the 5 Mbps stream data, it is judged whether the sending is possible or not, that is, the sending possibility judgment is performed in step S2541, and in step S2542, the sending to the terminal 2104 is determined to be impossible.

At this time, in step S2551, the terminal 2102 converts the sending data by reencoding the stream data or transcoding the data to a data format with a higher compression rate. For example, as shown in FIG. 30, communication band of 3.7 Mbps is available for the terminals 2102 and 2104, the 5 Mbps stream data which is requested to be sent is converted so that its resolution becomes about 3.7 Mbps by reencoding or transcoding. The converted stream data is sent at transmission rate of 12 Mbps to the terminals 2101, 2103 and 2104. The terminal 2102 can thus send the stream data to all of the terminals 2101, 2103 and 2104 that are participating in the network 2110a. In step S2543, in substantially the same manner as the fourth embodiment, the terminal 2102 sends to the terminal 2101 sending information which contains a sending terminal identifier, a receiving terminal identifier, a communication band in use, and a transmission rate in use, in accordance with the converted communication band. In the case described above, the terminal 2102 sends to the management terminal 2101 the sending information indicating that the sending terminal identifier is “2102” which specifies the terminal 2102, the receiving terminal identifiers are “2101”, “2103” and “2104” which specify the terminals 2101, 2103 and 2104 respectively, the communication band in use is 3.7 Mbps, and the transmission rate in use is 12 Mbps.

In the above description, the stream data converted to 3.7 Mbps is broadcasted from the terminal 2102 to all of the terminals 2101, 2103 and 2104. As described in the fourth embodiment with reference to FIG. 30, however, a communication band up to 11.2 Mbps is available by using a transmission rate of 48 Mbps in the data transmission from the terminal 2102 to the terminals 2101 and 2103. For this reason, the terminal 2102 can send the 5.0 Mbps stream data without conversion to the terminals 2101 and 2103.

At this time, as has been described in the fourth embodiment with reference to FIG. 33, the stream data which can be sent from the terminal 2102 to the terminal 2104 is 2.0 Mbps. Accordingly, the terminal 2102 converts the stream data from 5.0 Mbps to 2.0 Mbps, and sends the converted data to the terminal 2104. Thus performing, the terminal 2102 can sends the stream data with quality maintained to all of the terminals 2101, 2103 and 2104 that are participating in the network 2110a. Then, in step S2543, in substantially the same manner as the fourth embodiment, the terminal 2102 sends to the terminal 2101 the sending information which contains a sending terminal identifier, a receiving terminal identifier, a communication band in use, and a transmission rate in use, in accordance with the converted communication band. In the case described above, the terminal 2102 sends to the management terminal 2101 the sending information indicating that the sending terminal identifier is “2102” which specifies the terminal 2102, the receiving terminal identifiers are “2101” and “2103” which specify the terminals 2101 and 2103 respectively, the communication band in use is 5 Mbps, and the transmission rate in use is 48 Mbps, as well as the sending information indicating that the sending terminal identifier is “2102” which specifies the terminal 2102, the receiving terminal identifier is “2104” which specifies the terminal 2104, the communication band in use is 2 Mbps, and the transmission rate in use is 12 Mbps.

As has been described above, in the network band management method according to the fifth embodiment, even if it is determined that the sending that corresponds to the sending request cannot be performed at a current available communication band, the sending data is converted so as to be within a range of an available communication band. Therefore, in addition to the advantage of the fourth embodiment, the network band management method according to the fifth embodiment has an advantage that the data transmission can be performed by using the most of an available communication band, even if a communication band is insufficient for the sending.

Although the terminal 2102 converts the stream data in the fifth embodiment, the present invention is not limited to this example. The same effect can be obtained by providing equipments such as a STB and a TV which are connected to a terminal and have a function of converting the stream data, or equipments which have a function of converting the stream data and are placed between terminals and the equipments such as STB and TV.

### Sixth Embodiment

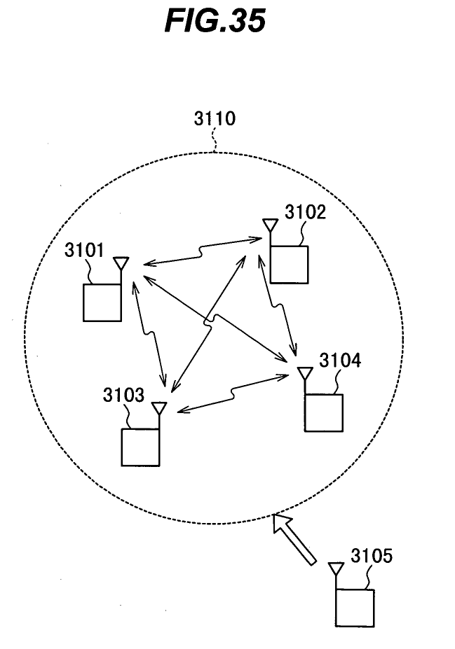

FIG. 35 is a diagram showing a configuration of a network 3110 to which the present invention is applied. As shown in FIG. 35, the wireless network 3110 is configured so that all terminals which form the wireless network 3110 can directly communicate with each other without using an access point. In FIG. 35, the wireless network 3110 is formed by wireless communication terminals 3101 to 3104. Further, in FIG. 35, a reference numeral 3105 denotes a wireless communication terminal (participation requesting terminal) which offers to newly participate in the wireless network 3110. Solid double-headed arrows in FIG. 35 indicate that the wireless communication terminals can directly communicate with each other. Furthermore, it is supposed here that the wireless network 3110 includes a single management terminal and the wireless communication terminal 3101 is the management terminal. The management terminal 3101 manages the network configuration of the wireless network 3110. When receiving a participation request from the terminal 3105 which offers to newly participate in the wireless network 3110, the management terminal 3101 confirms communication conditions between the participation requesting terminal 3105 and each of all terminals in the wireless network 3110, judges whether a condition for participating in the wireless network 3110 is satisfied or not, and notifies the participation requesting terminal 3105 that participation is permitted or that participation is not permitted. With respect to the terminals 3102 to 3104 that are participating in the wireless network 3110, the management terminal 3101 confirms the communication conditions with all participation terminals in the wireless network 3110 which are sent from the participation terminals 3102 to 3104, judges whether or not each of the participation terminals 3102 to 3104 satisfies the condition for participating in the wireless network, and excludes a terminal which does not satisfy the participation condition. The management terminal 3101 distributes the-network configuration to the participation terminals 3102 to 3104 at regular intervals, gives notice of the network configuration, and thus manages the network configuration. Furthermore, the participation requesting terminal 3105 which offers to newly participate in the wireless network confirms information (participation terminal information) of the participation terminals to the wireless network which is sent from the management terminal 3101, checks the communication conditions between all the participation terminals to the wireless network 3110 in accordance with the participation terminal information, sends the participation request and the communication condition to the management terminal 3101, and can participate in the wireless network 3110 if it is notified from the management terminal 3101 that the participation is permitted. The present embodiment describes an example of IEEE 802.11a, the present invention is not limited to this example. In this specification, a physical speed of the line is referred to as a transmission rate.

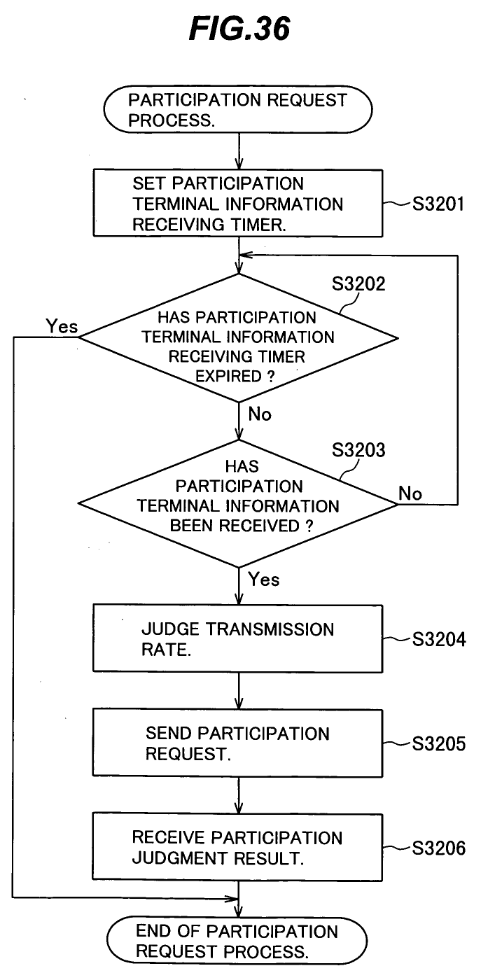

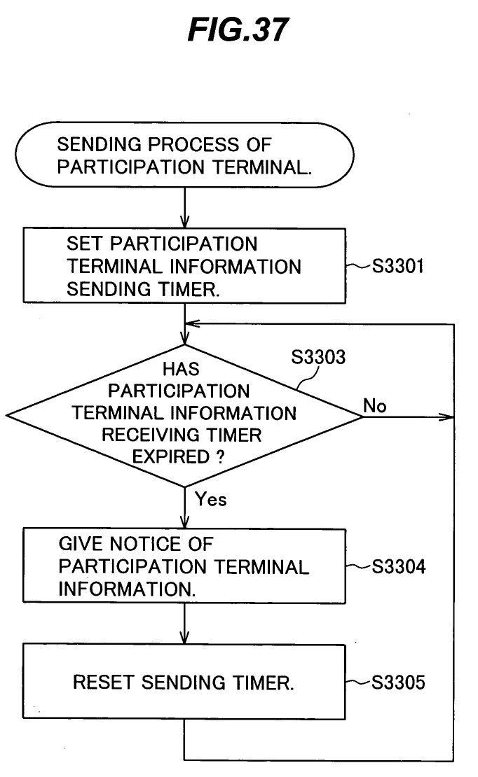

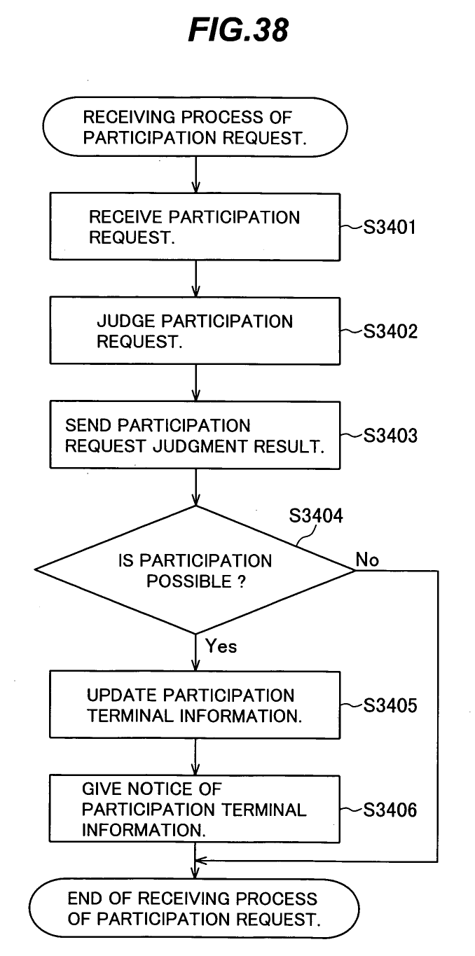

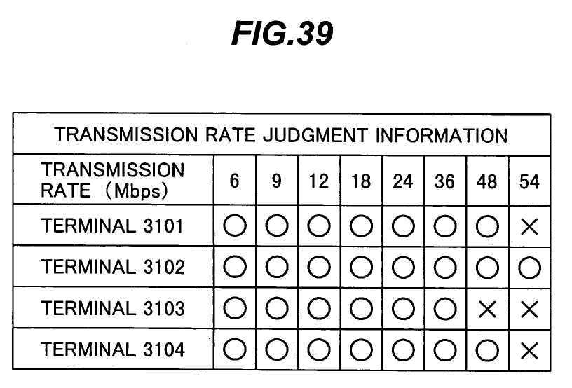

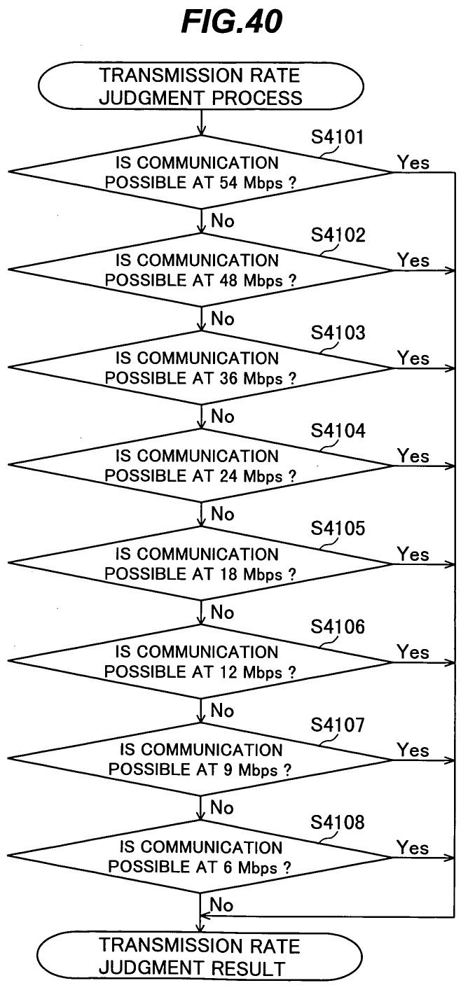

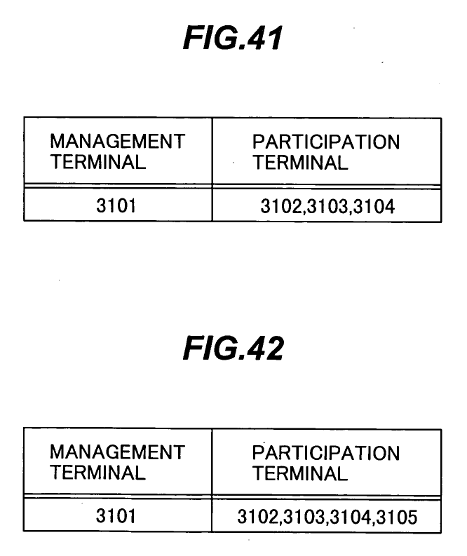

The sixth embodiment of the present invention will be described below with reference to FIG. 35 to FIG. 42. FIG. 36 is a flowchart showing the participation requesting operation of the participation requesting terminal 3105 which newly participates in the wireless network 3110 in the sixth embodiment. FIG. 37 is a flowchart showing the sending operation of the participation terminal information by the management terminal 3101 in the sixth embodiment. FIG. 38 is a flowchart showing the receiving operation of the participation request by the management terminal 3101 in the sixth embodiment. FIG. 39 is a diagram showing an example of the transmission rate judgment information between the participation requesting terminal 3105 and each of the wireless communication terminals 3101 to 3104 that are participating in the wireless network 3110 in the sixth embodiment. FIG. 40 is a flowchart showing an example of an operation when the participation requesting terminal 3105 performs the transmission rate judgment in the sixth embodiment. FIG. 41 and FIG. 42 are diagrams showing examples of the participation terminal information sent by the management terminal 3101 in the sixth embodiment.

The sending operation of the participation terminal information by the management terminal 3101 in the sixth embodiment will be described below with reference to FIG. 37. The management terminal 3101 in the wireless network 3110 holds participation terminal information which contains terminal information of wireless communication terminals participating in the wireless network 3110. The management terminal 3101 can acquire the wireless communication terminals that are participating in the wireless network 3110 from the participation terminal information. For example, the participation terminal information shown in FIG. 41 indicates that the wireless network 3110 is formed by the management terminal 3101 and the participation terminals 3102 to 3104. The sending operation of the participation terminal information by the management terminal 3101 will be described first. The management terminal 3101 sends the participation terminal information at predetermined intervals. As shown in FIG. 37, in the sixth embodiment, the management terminal 3101 first sets a participation terminal information sending timer (step S3301). Then, the management terminal 3101 determines whether the participation terminal information sending timer has expired or not (step S3303). If the participation terminal information sending timer has expired, the management terminal 3101 broadcasts the participation terminal information held by itself to the wireless network 3110 (step S3304), and resets the participation terminal information sending timer (step S3305). In step S3303, if the participation terminal information sending timer has not expired, the management terminal 3101 returns to a state of waiting for the participation terminal information.

Next, the participation requesting operation of the participation requesting terminal 3105 which newly participates in the wireless network in the sixth embodiment will be described with reference to FIG. 36. As shown in FIG. 36, the participation requesting terminal 3105 in the sixth embodiment first sets a participation terminal information receiving timer in order to determine whether or not the participation terminal information is broadcasted at regular intervals from the management terminal 3101 can be received (step S3201). Then, the participation requesting terminal 3105 confirms whether the participation terminal information receiving timer has expired or not (step S3202). When the timer has expired, it is determined that the participation requesting terminal 3105 cannot communicate with the management terminal 3101 of the network 3110 and cannot participate in the network. When the timer has not expired, the participation requesting terminal 3105 confirms whether or not the participation terminal information sent from the management terminal 3101 is received (step S3203). If the participation terminal information is not received, the participation requesting terminal 3105 returns to a state of confirming a participation terminal information receiving timer. When receiving the participation terminal information, the participation requesting terminal 3105 confirms using the participation terminal information in accordance with the participation terminal information, whether direct communication with the other wireless communication terminals, which are participating in the wireless network 3110, is possible by using each transmission rates, and judges whether or not communication with each of the wireless communication terminal is possible (i.e., communication availability) and judges available transmission rates (step S3204). When receiving the participation terminal information in FIG. 41, the participation requesting terminal 3105 judges the communication availability with the wireless communication terminals 3101 to 3104 and available transmission rates. An example of the transmission rate judging operation will be described with reference to FIG. 40. The participation requesting terminal 3105 confirms communication with each of the wireless communication terminals 3101 to 3104 at each transmission rate in descending order from 54 Mbps and judges available transmission rates. First, the participation requesting terminal 3105 performs communication at 54 Mbps and confirms whether communication is possible or not (step S4101). If there is a response from the other party, the participation requesting terminal 3105 determines that the communication at 54 Mbps is possible. As a result of the available transmission rate judgment, the communication is determined to be possible at transmission rate of 54 Mbps or less and thus the transmission rate judgment process terminates. At a lower transmission rate, fewer errors occur in view of modulation mode and coding rate in comparison with at a higher transmission rate and a larger range can be covered. For this reason, if the participation requesting terminal 3105 can communicate at a certain transmission rate, it can be determined that the communication is possible even if lower transmission rates are used. If there is no response from the other party, the participation requesting terminal 3105 determines that the 54 Mbps communication is impossible and then checks whether communication is possible at 48 Mbps, a next lower transmission rate (step S4102). Similarly, the participation requesting terminal 3105 confirms whether communication is possible or not at each of the transmission rates in descending order, and thus can judge at which transmission rate or less the communication is possible (steps S4103 to S4108). The participation requesting terminal 3105 judges whether communication at transmission rate of 6 Mbps is possible or not (step S4108) and when the communication is not possible, the participation requesting terminal 3105 judges that the communication terminals cannot communicate with each other. As described in the above example, the participation requesting terminal 3105 can judge the available transmission rates between the communication terminals.

As shown in FIG. 36, the participation requesting terminal 3105 performs the transmission rate judgment with respect to each of wireless communication terminals that are participating in the wireless network 3110 and then sends the participation request which contains the transmission rate judgment information to the management terminal 3101 (step S3205). The participation requesting terminal 3105 receives the participation judgment result to the participation request, and confirms whether or not participation in the wireless network 3110 is possible (i.e., participation permissibility), referring to the received participation judgment result (step S3206). If the participation judgment result indicates that the participation is possible, the participation requesting terminal 3105 determines that the participation in the wireless network 3110 is possible. On the other hand, if the participation judgment result indicates that participation is impossible, the participation requesting terminal 3105 determines that the participation in the wireless network 3110 is not possible and the participation requesting operation are terminated.

FIG. 39 shows an example of the judgment of the transmission rate between the participation requesting terminal 3105 and each of the wireless communication terminals 3101 to 3104 in the wireless network 3110 in the transmission rate judging step S3204. In FIG. 39, circles “◯” indicate that communication is available, while crosses “X” indicate that communication is unavailable. FIG. 39 shows, for example, that the participation requesting terminal 3105 can communicate with the wireless communication terminal 3101 by using the transmission rates of 6 Mbps, 9 Mbps, 12 Mbps, 18 Mbps, 24 Mbps, 36 Mbps and 48 Mbps, while the participation requesting terminal 3105 cannot communicate by using the transmission rate of 54 Mbps.

In the network participation judgment result receiving step S3206 shown in FIG. 36, a terminal determines that its own participation in the network is impossible and notifies a user of the determination, for example, by blinking a red lamp of an LED of the participation requesting terminal 3105. Thus, the user can be informed that the terminal fails to participate in the wireless network 3110, and also the user can take an appropriate measure, for example, to move the terminal which fails to participate in the wireless network 3110 to another place.

Next, the receiving operation of the participation request by the management terminal 3101 will be described with reference to the flowchart shown in FIG. 38. As shown in FIG. 38, the management terminal 3101 receives the participation request sent from the participation requesting terminal 3105 (step S3401), and judges, corresponding to the participation request, whether the participation in the wireless network 3110 is possible or not (step S3402) with reference to the transmission rate judgment information contained in the received participation request. For dealing with a video stream of 20 Mbps in the wireless network 3110, for example, if the available transmission rate by the participation requesting terminal 3105 is equal to or less than 24 Mbps, the substantial communication band is less than 20 Mbps (see FIG. 27) and the 20 Mbps video stream cannot be sent to all of the wireless communication terminals that are participating in the wireless network 3110. For this reason, in the wireless network which addresses a video stream of 20 Mbps, for example, by defining a condition for participating in the wireless network that communication is possible with each of the wireless communication terminals in transmission rate of 36 Mbps or more (as shown in FIG. 27, the communication band is 22 Mbps), a network which keeps a certain quality can be configured. The transmission rate judgment information contained in the received participation request is shown in FIG. 39. As shown in FIG. 39, if a condition for participating in the wireless network 3110 is that the transmission rate is 36 Mbps or more, because the participation requesting terminal 3105 can communicate with all the terminals in the wireless network 3110 at the transmission rate of 36 Mbps or more, the condition for participating in the wireless network 3110 is satisfied and it is determined that the participation in the wireless network 3110 is possible. In accordance with the participation request judgment result, the management terminal 3101 sends the participation judgment result of the participation request to the participation requesting terminal 3105 (step S3403). When the participation is determined to be possible with reference to the participation judgment result in step S3402 (step S3404), the management terminal 3101 updates the participation terminal information so as to contain the terminal identifier of the participation requesting wireless communication terminal (step S3405) in order to reconstruct the wireless network 3110. FIG. 42 shows an example of the updated participation terminal information. Then, the management terminal 3101 broadcasts the updated participation terminal information to the communication terminals in the wireless network 3110 (step S3406). Since the wireless network 3110 is not changed if it is determined that the participation requesting terminal 3105 cannot participate in the wireless network 3110, the management terminal 3101 terminates the process for the participation request receiving from the participation requesting terminal 3105.

As has been described above, according to the sixth embodiment, a terminal can newly participate in the wireless network 3110, and the participation terminal information containing the identifier of the newly participation terminal is sent to the network, a wireless network can be constructed so that all wireless communication terminals that are participating in network can directly communicate with each other at a predetermined constant transmission rate or more. Thus, a network which satisfies a certain communication quality required for sending the stream data such as the image data in the newly constructed network can be realized. Moreover, the communication using a low transmission rate can be eliminated and the network can be efficiently used, because the communication using the maximum available transmission rate can be performed by acquiring the available transmission rates.

### Seventh Embodiment

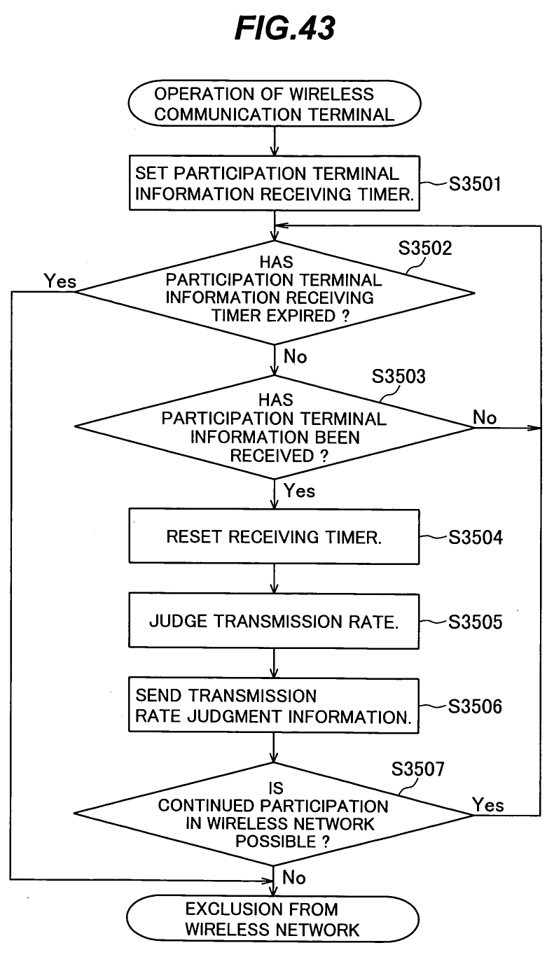

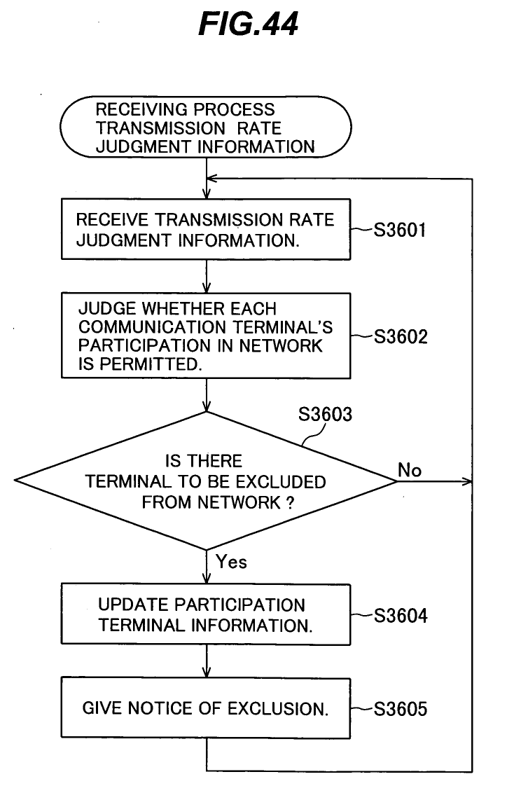

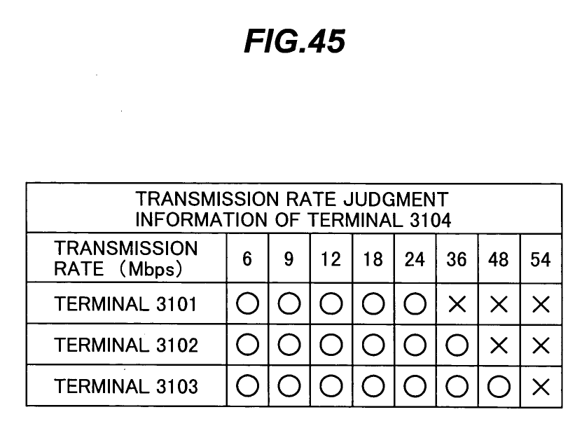

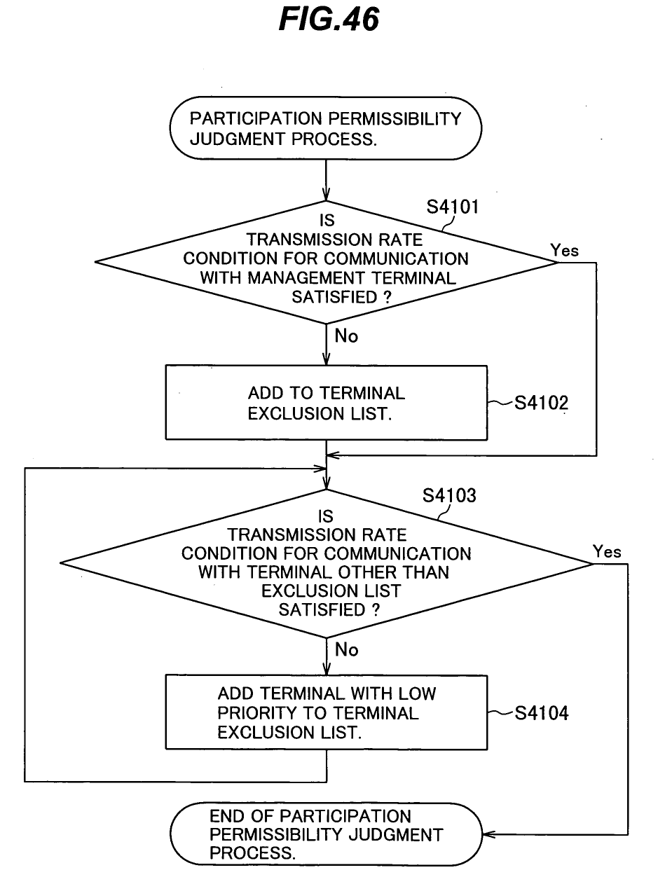

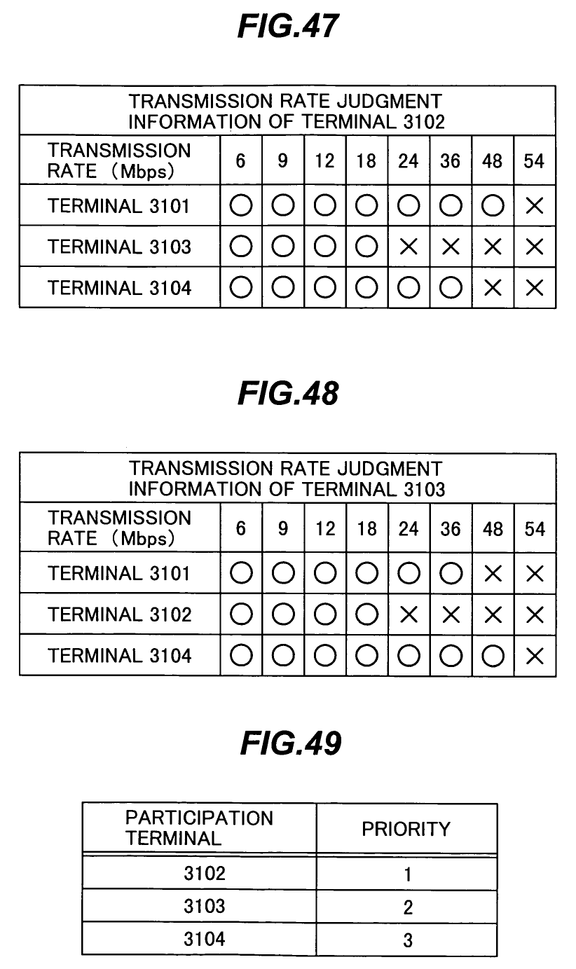

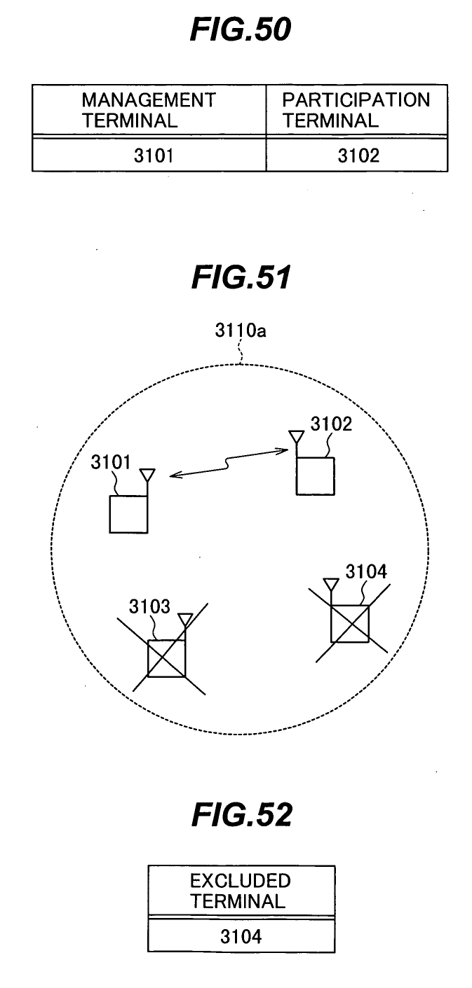

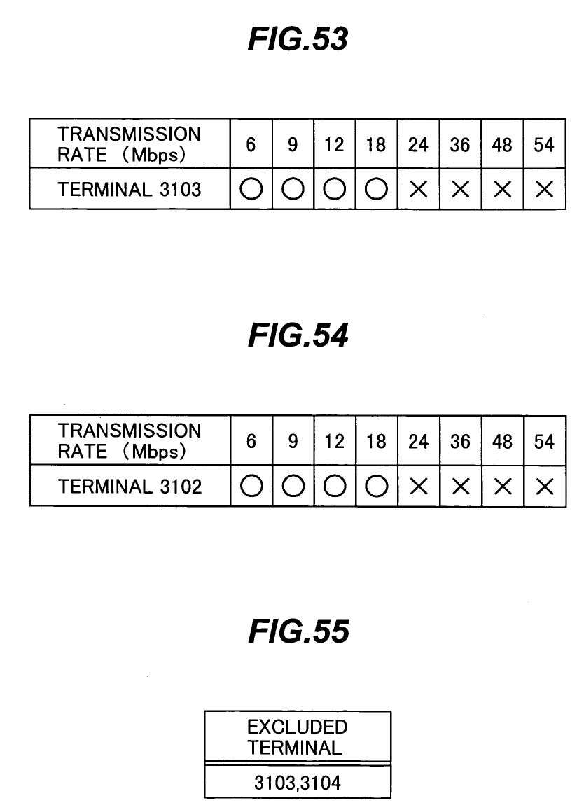

The seventh embodiment of the present invention will be described with reference to FIG. 35, FIG. 37 and FIG. 43 to FIG. 55. FIG. 43 is a flowchart showing an operation of the wireless communication terminals 3102 to 3104 in the seventh embodiment. FIG. 44 is a flowchart showing a receiving operation of the transmission rate judgment information by the management terminal 3101 in the seventh embodiment. FIG. 45 is a diagram showing an example of the transmission rate judgment information between the wireless communication terminal 3104 and the wireless communication terminals other than the wireless communication terminal 3104, which are participating in the wireless network 3110 in the seventh embodiment. FIG. 46 is a flowchart showing an example of the participation permissibility judging operation of a communication terminal in the receiving operation of the transmission rate judgment information performed by the management terminal shown in FIG. 44. FIG. 47 is a diagram showing an example of the transmission rate judgment information between the wireless communication terminal 3102 and the wireless communication terminals other than the wireless communication terminal 3102, which are participating in the wireless network 3110 in the seventh embodiment. FIG. 48 is a diagram showing an example of the transmission rate judgment information between the wireless communication terminal 3103 and the wireless communication terminals other than the wireless communication terminal 3103, which are participating in the wireless network 3110 in the seventh embodiment. FIG. 49 is a diagram showing an example of priority of the communication terminals that are participating in the wireless network 3110 in the seventh embodiment. FIG. 50 is a diagram showing an example of the participation terminal information which is sent by the management terminal 3101 in the seventh embodiment. FIG. 51 is a diagram showing an example of the network configuration when the network is reconstructed. FIG. 52 and FIG. 55 are diagrams showing examples of the terminal exclusion lists in the participation permissibility judgment operation by the management terminal 3101 in the seventh embodiment. FIG. 53 and FIG. 54 show transmission rate judgment information of the terminals 3102 and 3103 in the seventh embodiment, from which the transmission rates of the management terminal 3101 and the terminal 3104 are excluded. The management terminal 3101 in the seventh embodiment performs a participation terminal information sending process in substantially the same manner as that of the sixth embodiment (FIG. 37).

An operation in the receiving process of the transmission rate judgment information by the management terminal 3101 of the seventh embodiment will be described below with reference to a flowchart shown in FIG. 44. The management terminal 3101 receives the transmission rate judgment information from the wireless communication terminals 3102 to 3104 (step S3601). The transmission rate judgment information is obtained as a result of confirmation by each of the wireless communication terminals 3101 to 3104 confirms available transmission rates for direct communication with all the other wireless communication terminals that are participating in the wireless network. The transmission rate judgment information regarding a certain communication terminal indicates the wireless communication terminals that can communicate with the certain communication terminal and the available transmission rates for communication with the wireless communication terminals. By using the received transmission rate judgment information, the management terminal 3101 judges which wireless communication terminals can continue participating in the wireless network 3110, i.e., participation permissibility (step S3602), and determines whether or not there is a wireless communication terminal that should be excluded from the wireless network 3110 (step S3603). An example of the transmission rate judgment information between the wireless communication terminal 3104 and each of the wireless communication terminals 3101 to 3103 in the wireless network 3110 is shown in FIG. 45. In FIG. 45, circles “◯” indicate that communication is possible and crosses “X” indicates that communication is impossible. FIG. 45 indicates that the communication terminal 3104 and the management terminal 3101 can communicate at a transmission rate of 24 Mbps or less, for example.

A participation permissibility judgment operation that the management terminal 3101 determines whether or not there is any terminal that should be excluded from the wireless network 3110 using the received transmission rate judgment information will be described with reference to a flowchart in FIG. 46. Here, an operation will be described when the condition for participating in the wireless network 3110 is defined that the transmission rate is 36 Mbps or more. It is supposed that the management terminal 3101 receives the transmission rate judgment information shown in FIG. 47, FIG. 48 and FIG. 45, from the wireless communication terminals 3102 to 3104 in the wireless network 3110, respectively. First, the management terminal 3101 confirms whether the available transmission rates for communication with the management terminal meet the condition for participating in the network in accordance with each of the transmission rate judgment information (step S4101). Regarding the communication terminal 3102 and the communication terminal 3103, as shown in FIG. 47 and FIG. 48, since the available transmission rates for communication with the management terminal 3101 are 48 Mbps and 36 Mbps, respectively, the participation condition is satisfied. However, as shown in FIG. 45, with respect to the communication terminal 3104 and the management terminal 3101, since the available communication rate is equal to or less than 24 Mbps, the participation condition is not satisfied. For this reason, the management terminal 3101 adds the communication terminal 3104 to the excluded terminal list (FIG. 52). Here, the management terminal 3101 does not add any terminal to the terminal exclusion list if all the terminals satisfy the participation condition of the available transmission rates for communication with the management terminal. Next, by using the transmission rate information between the terminals other than the management terminal and the excluded terminal list (FIG. 53 and FIG. 54) of the transmission rate judgment information, the management terminal 3101 checks whether or not the transmission rate satisfies a condition for participating in the network 3110 (step S4103). The transmission rate information shown in FIG. 53 and FIG. 54 indicate that the available transmission rate between the terminal 3102 and the terminal 3103 is 18 Mbps or less, and therefore the condition for participating in the network 3110 is not satisfied. Accordingly, by using the priority shown in FIG. 49, the management terminal 3101 determines which of the terminal 3102 and the terminal 3103 is excluded from the network 3110. The priority in FIG. 49 indicates that the smaller number has the higher priority. For providing the terminals with the priority, for example, a user can set the priority when the user constructs a network, the priority can be provided in accordance with frequency of use monitored for each of the terminals, that is, high priority is provided to a frequently used equipment such as a TV in a living room and low priority is provided to a not-frequently used equipment such as a TV in a guest room and so forth. Since the priority is provided to the equipments in accordance with their frequency of use, a probability that frequently used equipments are excluded from the network is reduced and thus a network in which the frequently used equipments are held (i.e., they are not excluded from network) can be obtained. Since the priority of the terminal 3103 is lower than that of the terminal 3102 in the case of the priority shown in FIG. 49, the management terminal 3101 adds the terminal 3103 to the terminal exclusion list (step S4104 in FIG. 46), updates the terminal exclusion list as shown in FIG. 55, and performs a process of step S4103 again. At step S4103, since the available transmission rate between all communication terminals other than terminals listed in the terminal exclusion list satisfies the condition for participating in the network 3110, the management terminal 3101 terminates the participation permissibility judgment process.

If the management terminal 3101 determined that there is a wireless communication terminal that should be excluded from the wireless network 3110 in accordance with the terminal exclusion list, the management terminal 3101 updates the participation terminal information by deleting the terminal information of a wireless communication terminal that should be excluded from the participation terminal information that the management terminal holds (step S3604 in FIG. 44) and gives notice of exclusion to the wireless communication terminal which is excluded from the wireless network 3110 (step S3605 in FIG. 44). Then, the management terminal 3101 returns to a state of receiving the transmission rate judgment information (step S3601 in FIG. 44). If there is no wireless communication terminal that should be excluded from the wireless network 3110, the management terminal 3101 returns to a state of receiving the transmission rate judgment information. It is supposed, for example, that the wireless communication terminals 3103 and 3104 are excluded from the network as shown in the terminal exclusion list of FIG. 55, the management terminal 3101 updates the participation terminal information by deleting information regarding the wireless communication terminals 3103 and 3104 from the participation terminal information, as shown in FIG. 50, and the management terminal 3101 excludes the wireless communication terminals 3103 and 3104 from the network 3110 by notifying the wireless communication terminals 3103 and 3104 of their exclusion. A new wireless network 3110a which does not contain the excluded wireless communication terminals 3103 and 3104 is thus reconstructed, as shown in FIG. 51.

As has been described above, when the management terminal 3101 updates the participation terminal information, the updated participation terminal information is subsequently sent to each of the wireless communication terminals at regular intervals in accordance with the sending process of the participation terminal information shown in FIG. 37. For this reason, each of the wireless communication terminals can be informed of the reconstruction of the wireless network 3110 by receiving the updated participation terminal information and confirming the updated participation terminal information. Even if a wireless communication terminal cannot communicate with the management terminal 3101 and the transmission rate judgment information of the wireless communication terminal cannot be received, the terminal can be excluded from the wireless network 3110 by deleting terminal information of the wireless communication terminal from the participation terminal information and updating the participation terminal information. When the wireless communication terminal is excluded from the wireless network, the user receives information indicating which terminal has been excluded by a means for displaying a terminal identifier of the excluded wireless communication terminal on an LCD (for example, a means corresponding to the display section 1104 shown in FIG. 2 or the display section 2104 shown in FIG. 4), for example. A user thus receives information indicating which terminal has been excluded and that the wireless network configuration has changed and can take an appropriate measure, for example, to locate the excluded terminal in a place in which communication can be performed.

Next, operations of the wireless communication terminals 3102 to 3104 forming the wireless network in the seventh embodiment will be described with reference to a flowchart shown in FIG. 43. The wireless communication terminals 3102 to 3104 in the seventh embodiment set a participation terminal information receiving timer (step S3501) in order to determine whether the participation terminal information which is broadcasted by the management terminal 3101 at regular intervals can be received or not. The wireless communication terminals 3102 to 3104 confirm whether the participation terminal information receiving timer has expired or not (step S3502). If the timer has expired, the wireless communication terminals 3102 to 3104 determine that they cannot communicate with the management terminal 3101 of the wireless network 3110, and they determine that they cannot participate in the wireless network. If the timer has not expired, the wireless communication terminals 3102 to 3104 confirm whether the participation terminal information sent from the management terminal 3101 is received or not (step S3503). If the participation terminal information is not received, the wireless communication terminals return to a state of confirming the participation terminal information receiving timer. When receiving the participation terminal information, the wireless communication terminals 3102 to 3104 reset the participation terminal information receiving timer (step S3504), the terminals confirm available transmission rates for communicating directly with each of the other wireless communication terminals that are participating in the wireless network, by using the participation terminal information, and the wireless communication terminals 3102 to 3104 judge the available transmission rates for communication with each of the other wireless communication terminals (step S3505). For judging communication availability with each of the wireless communication terminals and the available transmission rates, the available transmission rates can be judged in substantially the same manner as the transmission rate judgment at step S3204 of the participation request process by the wireless communication terminal in the sixth embodiment. After performing the transmission rate judgment with respect to each of the wireless communication terminals that are participating in the network, the wireless communication terminal sends to the management terminal 3101 in accordance with the judgment result, transmission rate judgment information which indicates a currently available transmission rate for communication with each of the wireless communication terminals (step S3506).

Further, after sending the transmission rate judgment information, the wireless communication terminals 3102 to 3104 confirm whether or not the terminals have received a notice of exclusion from the management terminal 3101 and determine whether or not their own terminals can continue participating in the wireless network (step S3507). For example, when each of the wireless communication terminals 3102 to 3104 sends the transmission rate judgment information shown in FIG. 47, FIG. 48 and FIG. 45, respectively, to the management terminal 3101, and the management terminal 3101 sends a notice of exclusion to the communication terminal 3104, it is determined that the communication terminal 3104 cannot participate in the network 3110 and the communication terminal 3104 has been excluded from the network 3110. If the communication terminal judges that its own communication terminal is excluded from the wireless network 3010, the communication terminal notifies a user that its own communication terminal are excluded from the wireless network 3010, for example, by blinking a red lamp of an LED or the like. The user can be informed of the exclusion of the communication terminal and can take an appropriate measure for the excluded communication terminal, for example, moving the terminal to another place. If the communication terminal does not receive the notice of exclusion from the management terminal 3101 and determines that its own terminal can continue participating in the wireless network 3110, the communication terminal returns to a state of waiting for termination of the participation terminal information receiving timer (step S3502).

As has been described above, according to the seventh embodiment, the wireless communication terminals forming the wireless network 3110 can be managed. Even if an available transmission rate for communication with a wireless communication terminal does not satisfy a condition for participating in the network 3110 any more due to a change in a communication condition between each terminals, a wireless network can be constructed so that all of the wireless communication terminals participating in the network can directly communicate with each other at a predetermined rate or more. A network which satisfies a certain communication quality required for sending the stream data, such as images in the network, can be realized. Moreover, communication using low transmission rates can be reduced and the network can be sufficiently used, because communication using the available maximum transmission rate can be performed by acquiring-the available transmission rates.

### Eighth Embodiment

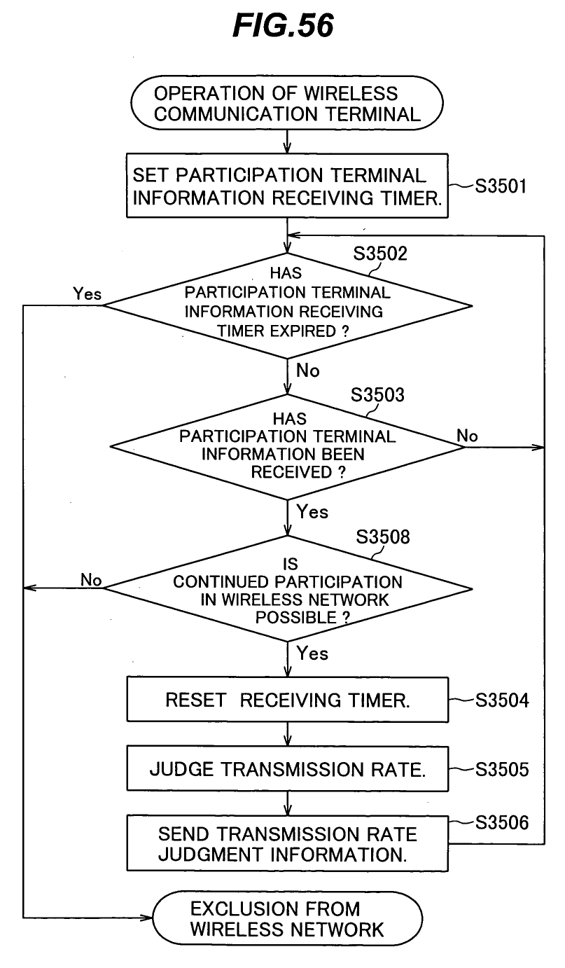

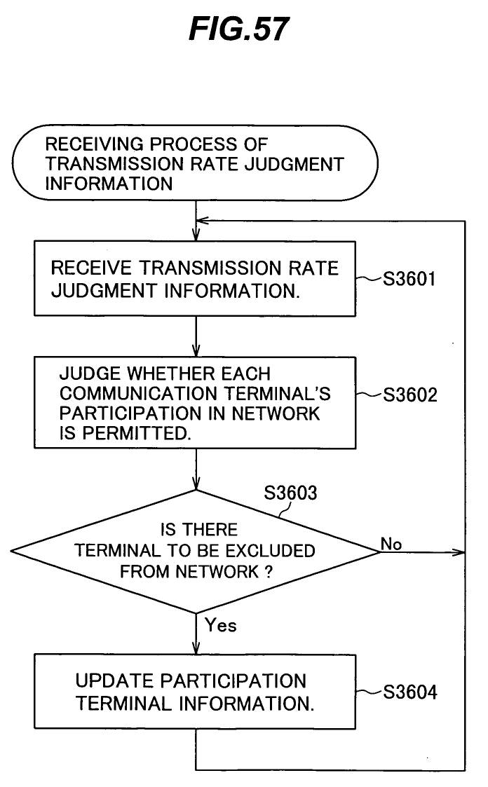

The eighth embodiment of the present invention will be described with reference to FIG. 56, FIG. 57, FIG. 41 and FIG. 50. FIG. 56 is a flowchart showing an operation of the wireless communication terminals 3102 to 3104 in the eighth embodiment. FIG. 57 is a flowchart showing a receiving operation of the transmission rate judgment information by the management terminal 3101 in the eighth embodiment.

Operations of the wireless communication terminals 3102 to 3104 forming the wireless network 3110 in the eighth embodiment will be described with reference to FIG. 56. At steps S3501, S3502 and S3503, the wireless communication terminals 3102 to 3104 operate in substantially the same manner as those of the seventh embodiment (FIG. 43). The wireless communication terminals 3102 to 3104 receive the participation terminal information which is sent from the management terminal 3101 at step S3503, and then confirm whether or not their own terminal information is contained in the received participation terminal information. If their own terminal information is contained in the received participation terminal information, the wireless communication terminals 3102 to 3104 determine that their own terminals can continue participating in the wireless network 3110. If their own terminal information is not contained in the received participation terminal information, the wireless communication terminals 3102 to 3104 determine that they cannot participate in the wireless network 3110 (step S3508). Since the participation terminal information is updated by deleting the terminal information of the wireless communication terminal that should be excluded from the wireless network 3110 in accordance with the transmission rate judgment information that the management terminal 3101 receives from each of the wireless communication terminals 3102 to 3104, each of the wireless communication terminals 3102 to 3104 can determine whether its own terminal is still participating in or has been excluded from the wireless network 3110 by confirming the participation terminal information.

The wireless communication terminals 3102 to 3104, which judge that their own terminals can continue participating in the wireless network 3110, reset the receiving timer (step S3504), judge the transmission rate (step S3505), send the transmission rate judgment information to the management terminal 3101 (step S3506), and return to a state of waiting for termination of the participation terminal information receiving timer (step S3502), in substantially the same manner as those of the seventh embodiment (FIG. 43).

Next, the receiving operation of the transmission rate judgment information by the management terminal 3101 forming the wireless network 3110 in the eighth embodiment will be described with reference to the flowchart shown in FIG. 57. The sending operation of the participation terminal information by the management terminal 3101 is substantially the same as that in the sixth embodiment (FIG. 37).

As shown in FIG. 57, the management terminal 3101 in the eighth embodiment performs the receiving operation of the transmission rate judgment information (FIG. 44) in the seventh embodiment, excepting the exclusion notification step (step S3605 in FIG. 44), to the wireless communication terminal excluded from the wireless network 3110. The management terminal 3101 in the eighth embodiment performs the receiving operation of the transmission rate judgment information at steps S3601 to S3604, in substantially the same manner as the receiving operation of the transmission rate judgment information at steps S3601 to S3604 in the seventh embodiment (FIG. 44). After updating the participation terminal information at step S3604, the management terminal 3101 returns to a state of receiving the transmission rate judgment. information (step S3601).

As has been described above, the wireless communication terminals 3102 to 3104 in the eighth embodiment determine whether their own terminals can continue participating in the wireless network 3110 or are excluded from the wireless network 3110 by confirming the participation terminal information which is sent from the management terminal 3101. When the management terminal 3101 excludes a wireless communication terminal from the wireless network 3110, the wireless communication terminal can be excluded from the wireless network 3110 without sending a notice of exclusion to the wireless communication terminal. For example, it is supposed that the management terminal 3101 which holds the participation terminal information shown in FIG. 41 before receiving the transmission rate judgment information from each of the wireless communication terminals, receives the transmission rate judgment information from each of the wireless communication terminals 3102 to 3104 that are participating in the wireless network 3110 and as a result of judging whether or not each of the wireless communication terminals can participate in the network 3110, the management terminal determines to exclude the wireless communication terminals 3103 and 3104 from the wireless network 3110. In this case, the management terminal 3101 deletes the terminal information of the wireless communication terminals 3103 and 3104 from the participation terminal information to update the participation terminal information, as shown in FIG. 50. After that, the management terminal 3101 performs the sending operation of the participation terminal information and the updated participation terminal information is accordingly sent to each of the wireless communication terminals 3102 to 3104. By referring the participation communication terminal information, each of the wireless communication terminals can judge whether or not its own terminal can participate in the network and thus the network can be reconstructed. When the participation terminal information shown in FIG. 50 is sent, the wireless communication terminal 3102 can continue participating in the wireless network 3110, while the wireless communication terminal 3102 can judge that the wireless communication terminals 3103 and 3104 are excluded from the network and cannot participate in the network.

As has been described above, according to the eighth embodiment, the wireless communication terminals forming the wireless network can be managed. Even if the transmission rate available for the communication with the wireless communication terminal does not satisfy the condition for participating in the network any longer due to a change in the communication condition between the terminals, the wireless network can be constructed so that all wireless communication terminals participating in the network can directly communicate with each other at a predetermined rate or more. Therefore, a network which satisfies certain communication quality required for sending the stream data such as images in the network can be realized. Moreover, since the communication using the available maximum transmission rate can be performed by acquiring the available transmission rates, the communication using low transmission rates can be reduced and the network can be efficiently used.

### MODIFIED EXAMPLES OF SIXTH TO EIGHTH EMBODIMENTS

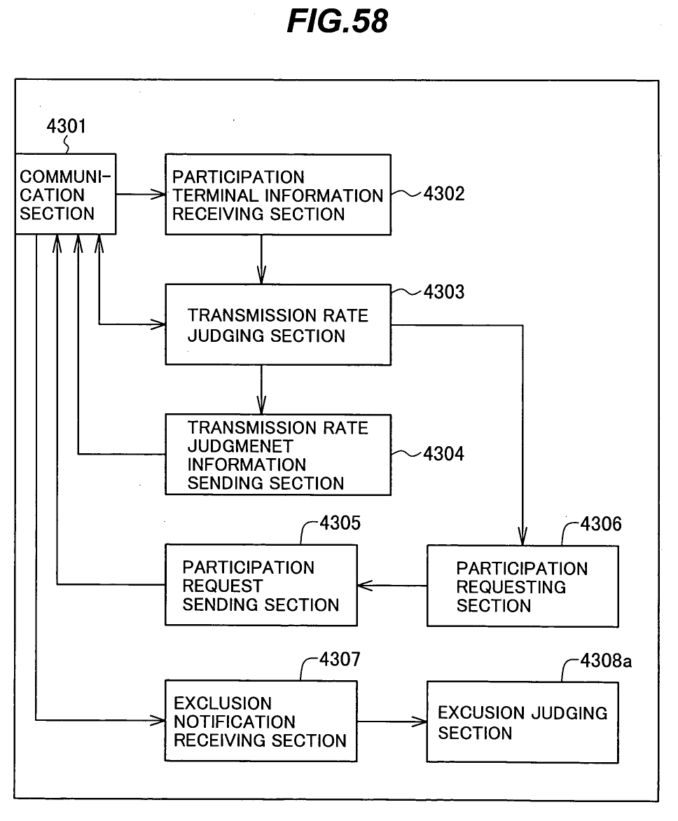

Although the above-described sixth to eighth embodiments show examples of performing the network configuration management method by software, it is also available that the communication terminals have hardware (H/W) configurations shown in FIG. 58 to FIG. 60 in order to have the functions described in the sixth to eighth embodiments.

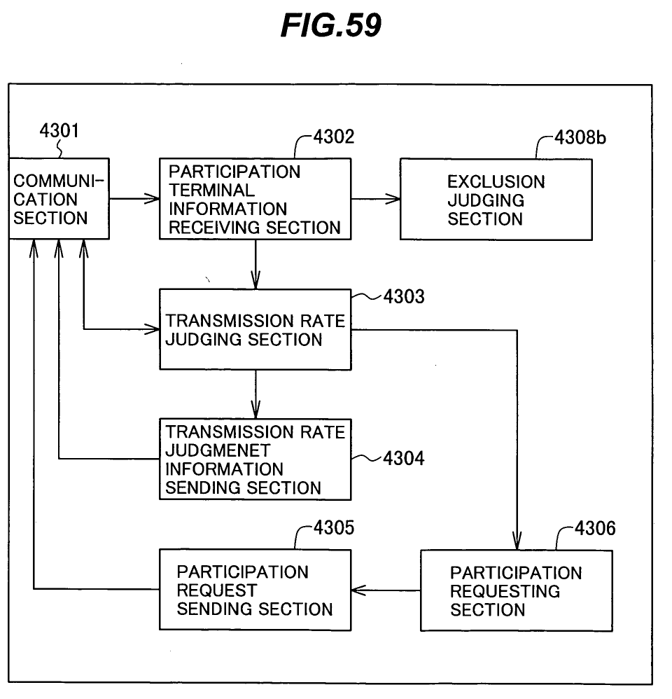

FIG. 58 is a diagram showing a configuration of the communication terminal 3105 in the sixth embodiment. The communication terminal 3105 shown in FIG. 58 includes a communication section 4301, a participation terminal information receiving section 4302, a transmission rate judging section 4303, a transmission rate judgment information sending section 4304, a participation request sending section 4305, a participation requesting section 4306, an exclusion notification receiving section 4307, and an exclusion judging section 4308a. Further, FIG. 59 is a diagram showing another configuration of the communication terminal 3105 in the sixth embodiment. The communication terminal 3105 shown in FIG. 59 includes a communication section 4301, a participation terminal information receiving section 4302, a transmission rate judging section 4303, a transmission rate judging information sending section 4304, a participation request sending section 4305, a participation requesting section 4306, and an exclusion judging section 4308a.

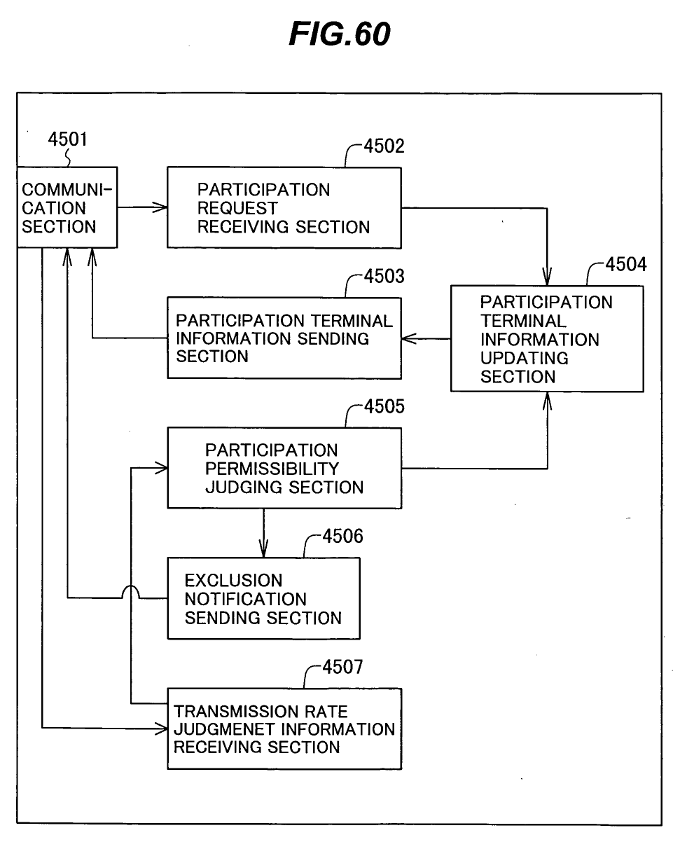

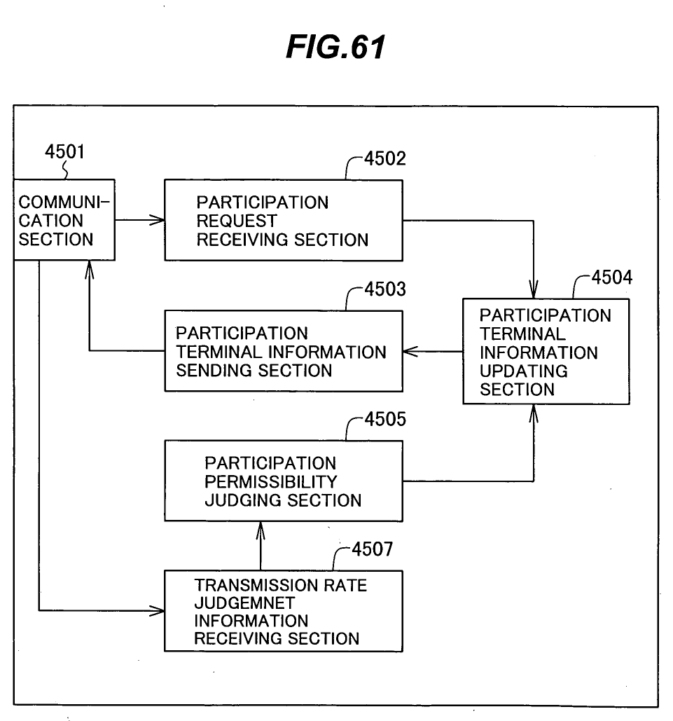

Furthermore, FIG. 60 is a diagram showing a configuration of the management terminal 1100 in the sixth embodiment. The management terminal 1100 shown in FIG. 60 includes a communication section 4501, a participation request receiving section 4502, a participation terminal information sending section 4503, a participation terminal information updating section 4504, a participation permissibility judging section 4505, an exclusion notification sending section 4506, a transmission rate judgment information receiving section 4507, and a transmission rate judging section 4508. Moreover, FIG. 61 is a diagram showing another configuration of the management terminal 1100 in the sixth embodiment. The management terminal 1100 shown in FIG. 61 includes a communication section 4501, a participation request receiving section 4502, a participation terminal information sending section 4503, a participation terminal information updating section 4504, a participation permissibility judging section 4505, an exclusion notification sending section 4506, and a transmission rate judgment information receiving section 4507. If the CPU controls the network configuration management flow described above, the same effect can be obtained by controlling in accordance with the flowcharts of FIG. 36 to FIG. 44, FIG. 56 and FIG. 57.

In the sixth to eighth embodiments, a wireless network is used as a network for an example. However, the present invention is not limited to this example. The present invention can be applied to a network such as a high-speed PLC, in which communication with a terminal in the network may become unavailable due to the changes in the communication condition between each of the terminals as in a wireless network. The network may include a plurality of communication terminals having unique terminal identifiers, wherein one of the communication terminals is a management terminal and all the participation communication terminals can directly communicate with each other. Further, the network configuration management method may include the steps of comprising the following steps: receiving the participation terminal information of a communication terminal participating in the network, the information which is sent from the management terminal at regular intervals; judging communication availability with all the communication terminals that are participating in the network in accordance with the participation terminal information; and sending the communication availability judgment result to the management terminal; wherein if a terminal cannot communicate with all of the communication terminals as a result of the communication availability judgment result, the terminal is controlled so as to exclude its own terminal from the network in accordance with a notice of exclusion from the network which is sent from the management terminal. In this case, the same effect can be obtained.

A wireless network is used as a network to be managed in the first to eighth embodiments described above. However, the present invention is not limited to this example. The present invention can be also applied to a wired network such as a high-speed power line communication (high-speed PLC) in which communication terminals in the network may not communicate with each other due to a change in communication condition between the communication terminals.

1. A network configuration management method for managing a network configuration in such a way that a participation terminal device can directly communicate with another participation terminal device, wherein a network includes a plurality of communication terminal devices each having a unique terminal identifier, one of the plurality of communication terminal devices is a management terminal device, and a communication terminal device which is permitted by the management terminal device to participate in the network is the participation terminal device; the network configuration management method comprising the steps of:
sending from the management terminal device, participation terminal information stored in the management terminal device;
receiving by the participation terminal device other than the management terminal device, the participation terminal information sent from the management terminal device;
judging by the participation terminal device other than the management terminal device, whether or not the participation terminal device can communicate with another participation terminal device that is participating in the network;
sending a communication availability judgment result obtained by the step of judging, from the participation terminal device other than the management terminal device to the management terminal device; and
determining by the management terminal device, a participation terminal device that should be excluded from the network in accordance with the communication availability judgment result, and deleting by the management terminal device, the participation terminal device that should be excluded from the network from the participation terminal information, thereby updating the participation terminal information stored in the management terminal device.

2. The network configuration management method according to claim 1, wherein, when there is a participation terminal device that should be excluded from the network, the step of updating the participation terminal information includes a process of sending a notice of exclusion for notifying that the participation terminal device that should be excluded is excluded from the network, from the management terminal device to the participation terminal device that should be excluded.

3. The network configuration management method according to claim 1, wherein the judging in the step of judging whether or not the participation terminal device can communicate with another participation terminal device, includes
a process of sending data for the communication availability judgment at regular intervals from the participation terminal device other than the management terminal device to another participation terminal device that is participating in the network, and
a process of judging whether or not the participation terminal device that has received the data for communication availability judgment can communicate in accordance with the received data for communication availability judgment.

4. The network configuration management method according to claim 1, further comprising the step of performing an indication, by the participation terminal device that has been excluded from the network, for notifying a user of a fact that the participation terminal device has been excluded from the network.

5. The network configuration management method according to claim 1, further comprising the step of performing an indication, by the management terminal device, for notifying a user of a fact that the participation terminal device is excluded from the network.

6. A management communication terminal device for managing a network configuration in such a way that a participation terminal device can directly communicate with another participation terminal device, wherein a network includes a plurality of communication terminal devices each having a unique terminal identifier, one of the plurality of communication terminal devices is the management communication terminal device, and a communication terminal device which is permitted by the management communication terminal device to participate in the network is the participation terminal device; the management communication terminal device comprising:
a communication section which performs communication;
a storage section which stores participation terminal information regarding the participation terminal device which is permitted to participate in the network; and
a control section;
wherein the control section controls so as to perform and repeat
a process of sending the participation terminal information stored in the storage section from the communication section;
a process of receiving communication availability judgment result, after receiving the sent participation terminal information, from a participation terminal device which sends the communication availability judgment result indicating whether or not communication can be performed with another participation terminal device that is participating in the network, another participation terminal device being other than the management communication terminal device; and
a process of determining a participation terminal device that should be excluded from the network in accordance with the communication availability judgment result, and deleting the participation terminal device that should be excluded from the network from the participation terminal information, thereby updating the participation terminal information.

7. The management communication terminal device according to claim 6, wherein, when the participation terminal information is updated, if there is a participation terminal device that should be excluded from the network, the management communication terminal device sends a notice of exclusion for notifying the participation terminal device that should be excluded from the network of a fact that the participation terminal device that should be excluded is excluded from the network.

8. A communication terminal device other than a management terminal device, wherein a network includes a plurality of communication terminal devices each having a unique terminal identifier, one of the plurality of communication terminal devices is the management terminal device, and a communication terminal device which is permitted by the management terminal device to participate in the network is the participation terminal device; the communication terminal device comprising:
a communication section which performs communication;
a storage section which stores the participation terminal information regarding the participation terminal device which is permitted to participate in the network and communication availability judgment result; and
a control section;
wherein the control section controls so as to perform and repeat
a process of judging whether communication with another participation terminal device that is participating in the network can be performed or not; and
a process of sending the communication availability judgment result obtained by the process of judging to the management terminal device.

9. The communication terminal device according to claim 8, wherein the judgment at the process of judging whether the communication with the participation terminal device can be performed or not, includes:
a process of sending data for the communication availability judgment at regular intervals from the participation terminal device other than the management terminal device to another participation terminal device that is participating in the network, and
a process of judging whether or not the participation terminal device other than the management terminal device that has received the data for communication availability judgment can communicate in accordance with the received data for communication availability judgment.

10. The communication terminal device according to claim 8, wherein
the participation terminal device excluded from the network comprises a display section, and
the display section displays so as to notify a user that the own communication terminal device has been excluded from the network.

11. A network band management method used in a network that comprises a plurality of communication terminals including a single management terminal and a plurality of managed terminals, the plurality of the communication terminals in the network directly communicating with each other; the network band management method comprising the steps of:
giving notice of sending information which contains information regarding band for data transmission being used by the plurality of managed communication terminals, from the plurality of the managed terminals to the management terminal;
generating by the management terminal, band-in-use information regarding a band being used in the network in accordance with the notified sending information; and
giving notice of the generated band-in-use information from the management terminal to the plurality of the managed terminals.

12. The network band management method according to claim 11, further comprising the step of determining by the communication terminal whether a predetermined amount of data can be sent or not in accordance with the band-in-use information which is notified in the step of giving notice of the band-in-use information.

13. The network band management method according to claim 12, further comprising the step of notifying a user of a result of the determination whether the predetermined amount of data can be sent or not, by the communication terminal.

14. The network band management method according to claim 12, further comprising the step of converting by the communication terminal, the predetermined amount of data to be within the available communication band in accordance with the band-in-use information in order to send the converted data, when the predetermined amount of data is determined not to be able to be sent.

15. The network band management method according to claim 11, wherein the step of giving notice of the band-in-use information is performed in accordance with a notification request from the managed terminal to the management terminal.

16. A network participation method for participating in a network by a participation requesting terminal, wherein the network includes a plurality of communication terminals each having a unique terminal identifier, one of the plurality of communication terminals is a management terminal, and the communication terminals that are participating in the network can directly communicate with each other and can acquire available transmission rates each other; the network participation method comprising the steps of:
receiving participation terminal information of the communication terminal that is participating in the network, the participation terminal information being sent from the management terminal at regular intervals;
judging communication availability judgment indicating whether communication with the communication terminals that are participating in the network can be performed and available transmission rates in accordance with the participation terminal information;
sending a participation request which contains a result of the transmission rate judgment to the management terminal;
receiving a participation permissibility judgment result indicating whether the participation requesting terminal can participate in the network or not, the participation permissibility judgment result being sent from the management terminal, as a result of the participation request sending; and
determining network participation permissibility in accordance with the received participation permissibility judgment result.

17. The network participation method according to claim 16, wherein the step of receiving the participation permissibility judgment result includes the step of notifying a user that the communication terminal has failed to participate in the network, when the participation requesting terminal receives a judgment result indicating not to be able to participate in the network.

18. A network configuration management method for managing a network configuration by a management terminal, wherein the network includes a plurality of communication terminals each having a unique terminal identifier, one of the plurality of communication terminals is the management terminal, and the communication terminals that are participating in the network can directly communicate with each other and can acquire available transmission rates each other; the network configuration management method comprising the steps of:
giving notice of participation terminal information of the communication terminal that is participating in the network, to the communication terminal in the network, by broadcasting at regular intervals;
receiving a participation request being sent from a participation requesting terminal requesting to newly participate in the network, the participation request which contains communication availability information indicating whether communication with the communication terminals that is participating in the network can be performed or not and a result of available transmission rate judgment;
judging whether participation of the participation requesting terminal in the network can be permitted or not in accordance with the received participation request;
sending a network participation permissibility judgment result regarding the participation of the participation requesting terminal to the participation requesting terminal;
updating the participation terminal information in accordance with the participation permissibility judgment, if the participation requesting terminal can participate in the network; and
sending the participation terminal information to the communication terminal that is participating in the network, if the participation terminal information is updated.

19. A network configuration management method for managing a network configuration, wherein the network includes a plurality of communication terminals each having a unique terminal identifier, one of the plurality of communication terminals is the management terminal, and the communication terminals that are participating in the network can directly communicate with each other and can acquire available transmission rates each other; the network configuration management method comprising the steps of:
receiving by a certain communication terminal, participation terminal information of the communication terminal that is participating in the network, the participation terminal information being sent from the management terminal at regular intervals, the certain communication terminal being one of the plurality of communication terminals forming the network, the certain communication terminal being other than the management terminal;
judging by the certain communication terminal other than the management terminal, communication availability indicating whether communication with the communication terminals that are participating in the network can be performed or not and available transmission rates in accordance with the participation terminal information;
sending by the certain communication terminal other than the management terminal, a result of the transmission rate judgment to the management terminal as transmission rate judgment information; and
excluding by the certain communication terminal other than the management terminal, the certain communication terminal from the network in accordance with a notice of exclusion being sent from the management terminal, if the certain communication terminal cannot communication with the other communication terminals that are participating in the network at a predetermined transmission rate or more, as a result of the transmission rate judgment.

20. A network configuration management method according to claim 19, wherein the step of excluding includes the steps of:
confirming whether the received participation terminal information from the management terminal contains the terminal information, after the sending of the transmission rate judgment information; and
judging that the certain communication terminal is participating in the network if the participation terminal information contains information of the certain communication terminal, and judging that the certain communication terminal has been excluded from the network if the participation terminal information does not contain the information of the certain communication terminal.

21. The network configuration management method according to claim 19, wherein the excluding step includes the step of notifying a user of the exclusion of the certain communication terminal from the network, when the certain communication terminal is judged that should be excluded from the network.

22. A network configuration management method for managing a network configuration by a management terminal, wherein the network includes a plurality of communication terminals each having a unique terminal identifier, one of the plurality of communication terminals is the management terminal, and the communication terminals that are participating in the network can directly communicate with each other and can acquire available transmission rates each other; the network configuration management method comprising the steps of:
giving notice of participation terminal information of the communication terminal that is participating in the network, to the communication terminal in the network, by broadcasting at regular intervals;
receiving a confirmation result of available transmission rates for communication with each of the communication terminals by the communication terminal that is participating in the network; and
determining whether the communication terminal can participate in the network or not in accordance with the received transmission rate information, and deleting terminal information of a communication terminal being determined not to be able to participate in from the participation terminal information, thereby excluding the communication terminal from the network.

23. The network configuration management method according to claim 22, further comprising the step of notifying a user of the exclusion of the communication terminal from the network, when the communication terminal that is participating in the network was excluded.

24. A communication terminal device requesting to participate in a network, wherein the network includes a plurality of communication terminals each having a unique terminal identifier, one of the plurality of communication terminals is a management terminal, and the communication terminals that are participating in the network can directly communicate with each other and can acquire available transmission rates each other; the communication terminal device comprising:
a participation terminal information receiving means for receiving participation terminal information of the communication terminals that are participating in the network, the participation terminal information being sent from the management terminal at regular intervals;
a transmission rate judging means for judging communication availability indicating whether or not communication with the communication terminal that is participating in the network can be performed and available transmission rates in accordance with the participation terminal information;
a participation request sending means for sending a participation request which contains a result of the transmission rate judgment to the management terminal;
a participation judgment result receiving means for receiving a result of participation permissibility judgment indicating whether the participation requesting terminal can participate in the network or not, the participation permissibility judgment result being sent from the management terminal as a result of the participation request sending; and
a determining means for determining the network participation permissibility in accordance with the received participation judgment result.

25. The communication terminal device according to claim 24, further comprising a means for notifying a user that the communication terminal has failed to participate in the network, when the participation judgment result receiving means receives a judgment result indicating that the own communication terminal cannot participate in the network.

26. A communication terminal device as a management terminal which is one of a plurality of communication terminals forming a network, wherein the network includes the plurality of communication terminals each having a unique terminal identifier, one of the plurality of communication terminals is the management terminal, and the communication terminals that are participating in the network can directly communicate with each other and can acquire available transmission rates each other; the communication terminal device comprising:
a participation terminal information notifying means for giving notice of participation terminal information of the communication terminal that is participating in the network to the communication terminals that are participating in the network by broadcasting at regular intervals;
a participation request receiving means for receiving communication availability information indicating whether communication with the communication terminal that is participating in the network can be performed or not and a participation request which contains an available transmission rate judgment result, being sent from a participation requesting terminal which offers to newly participate in the network;
a participation request judging means for judging the network participation permissibility of the participation requesting terminal in accordance with the received participation request;
a participation request judgment result sending means for sending a participation permissibility judgment result whether the participation requesting terminal can participate in the network or not, to the participation requesting terminal;
a participation terminal information updating means for updating the participation terminal information, when the participation requesting terminal is judged to be able to participate in the network, in accordance with the participation permissibility judgment; and
a sending means for sending the participation terminal information to the communication terminal that is participating in the network, when the participation terminal information is updated.

27. A communication terminal device other than a management terminal, which is one of a plurality of communication terminals forming a network, wherein the network includes the plurality of communication terminals each having a unique terminal identifier, one of the plurality of communication terminals is the management terminal, and the communication terminals that are participating in the network can directly communicate with each other and can acquire available transmission rates each other; the own communication terminal device comprising:
a participation terminal information receiving means for receiving participation terminal information of a communication terminal that is participating in the network, the participation terminal information which is sent from the management terminal at regular intervals;
a transmission rate judging means for judging communication availability judgment indicating whether communication with the communication terminals that are participating in the network can be performed or not and available transmission rates for communication, in accordance with the participation terminal information;
a transmission rate judgment information sending means for sending to the management terminal the transmission rate judgment result as transmission rate judgment information; and
an excluding means for excluding the own communication terminal device from the network in accordance with a notice of exclusion which is sent from the management terminal, as a result of the transmission rate judgment, when the communication terminal device fails to communicate with the communication terminal that is participating in the network at a predetermined transmission rate or more.

28. The communication terminal device according to claim 27, wherein when the communication terminal device excludes the own communication terminal from the network, after sending the transmission rate judgment information, the communication terminal device confirms whether the participation terminal information which is received from the management terminal contains the own communication terminal information, judges that the own communication terminal is participating in the network if the participation terminal information contains the own communication terminal information, and judges that the own communication terminal is excluded from the network if the participation terminal information does not contain the own communication terminal information.

29. The communication terminal device according to claim 27, further comprising a means for notifying a user of the exclusion of the communication terminal from the network, when the own communication terminal is judged that should be excluded from the network by the network exclusion means.

30. A communication terminal device as a management terminal which is one of a plurality of communication terminals forming a network, wherein the network includes the plurality of communication terminals each having a unique terminal identifier, one of the plurality of communication terminals is the management terminal, and the communication terminals that are participating in the network can directly communicate with each other and can acquire available transmission rates each other; the communication terminal device comprising:
a participation terminal information notifying means for giving notice of participation terminal information of the communication terminal that is participating in the network, to the communication terminal that is participating in the network by broadcasting at regular intervals;
a transmission rate judgment information receiving means for receiving a confirmation result of available transmission rates for communication between the communication terminal that is participating in the network and each of the communication terminals; and
determining whether the communication terminal can participate in the network or not in accordance with the received transmission rate information in accordance with the transmission rate judgment information received at the transmission rate judgment information receiving means, and deleting terminal information of a communication terminal being determined not to be able to participate in from the participation terminal information, thereby excluding the communication terminal from the network.

31. The communication terminal device according to claim 30, further comprising a means for notifying a user that the communication terminal has been excluded from the network, when the communication terminal that is participating in the network was excluded from the network by the network exclusion means.
